(19) United States
(12) Patent Application Publication
(10) Pub. No.: US 2026/0184629 A1
(43) Pub. Date: Jul. 2, 2026

(54) PHOTONIC WIRE BONDING METHODS AND PROCESSES FOR THE ADVANCED PACKAGING OF PHOTONIC DEVICES AND SYSTEMS

(71) Applicants: AEPONYX INC., MONTREAL (CA); VANGUARD AUTOMATION GMBH, KARLSRUHE (DE)

(72) Inventors: ASSANE NDIEGUENE, GRANBY (CA); MARTIN BERARD, STE-CATHERINE-DE-LA-JACQUES CARTIER (CA); ANDRE FEKECS, SHERBROOKE (CA); ANNABELLE GASCON, VERDUN (CA); YANNICK LAPIERRE, MONTREAL (CA); CEDRIK COIA, GREENFIELD PARK (CA); DAMIEN MICHEL, BROMONT (CA); SEBASTIAN SKACEL, KARLSRUHE (DE); MATTHIAS LAUERMANN, KARLSRUHE (DE); STEFFEN SCHLOER, KARLSRUHE (DE); MUHAMMAD BILLAH, KARLSRUHE (DE); PHILIPP DIETRICH, WORTH (DE)

(21) Appl. No.: 19/544,139

(22) Filed: Feb. 19, 2026

Related U.S. Application Data
(62) Division of application No. 18/838,843.
(60) Provisional application No. 63/268,447, filed on Feb. 24, 2022.

(51) Int. Cl. C03C 27/06; G02B 6/25

(52) U.S. Cl. CPC C03C 27/06; G02B 6/25

(57) ABSTRACT

Silicon photonics technologies adds integrated optics functionality to CMOS integrated circuits thereby leveraging high volume manufacturing. Independent of geometry or technology these silicon photonic devices require packaging with single mode optical fibers to interface to the optical network and/or co-packaging with active semiconductor devices, discrete microoptoelectromechanical systems (MOEMS)s or monolithically integrated MOEMS. Stringent performance constraints and minimizing manufacturing costs/times are consistent demands on such photonic circuits. Accordingly, there is a demand for low-cost and low-loss optical coupling technologies for packaging that can easily be scaled for mass production that overcome limitations in the prior art. The inventors have established design methodologies, packaging schemes and component designs that leverage automated passive assembly techniques for speed/cost in combination with directly written optical interconnects that allow for offsetting the losses that would arise from the manufacturing tolerances of these passive assembly techniques.

### CROSS-REFERENCE TO RELATED APPLICATIONS

This patent application claims the benefit of priority as a divisional application of U.S. patent application Ser. No. 18/838,843, filed Aug. 15, 2024; which itself claims the benefit of priority as a 371 national phase entry application of Intl. Patent Application No. PCT/CA2023/050228, filed Feb. 24, 2023; which itself claims the benefit of priority from U.S. Provisional Ser. No. 63/268,447 , filed Feb. 24, 2022.

### FIELD OF THE INVENTION

This invention is directed to integrated optical components and more particularly to establishing structures and methods for packaging discrete integrated optical components and assembling integrated optical component sub-assemblies based upon photonic wire bonds and photonic wire bonding techniques.

### BACKGROUND OF THE INVENTION

Silicon photonics is a promising technology for adding integrated optics functionality to integrated circuits by leveraging the economies of scale of the CMOS microelectronics industry. Variants of silicon photonics may use other materials for the waveguide core such as silicon nitride (SiₓN_{y}) and silicon oxynitride (SiOₓN₁₋ₓ) for example with lower claddings of silicon dioxide (silica, SiO₂) or silicon oxynitride (SiOₓN₁₋ₓ) and upper claddings of air, silicon dioxide (silica, SiO₂) or silicon oxynitride (SiOₓN₁₋ₓ) for example.

However, independent of the waveguide geometry or technology these silicon photonic devices require packaging with standard single mode glass optical fibers with a standard glass cladding diameter of 125 microns in order to interface to the optical network they are intended to form part of. In other instances passive silicon photonic devices require co-packaging with active semiconductor devices such as light emitting diodes (LEDs), laser diodes (LDs), photodetectors (PDs) and avalanche photodetectors (APDs) in addition to optical fibers to provide the desired optical functionality. Similarly, other passive photonic devices may require co-packaging with discrete microoptoelectromechanical systems (MOEMS) elements or interfacing with monolithically integrated MOEMS elements.

This packaging of silicon photonics is increasingly challenging as long-haul signal transmission becomes a dominant paradigm in data transmission as well as local area networks etc. Accordingly, stringent constraints on insertion losses, low-signal sensitivity, and cost surround the packaging process for silicon photonics such that optical interconnectivity losses within the systems or sub-systems and manufacturing costs/times are minimized. As prior art methodologies such as fiber attach, free space optics (lenses for instance), or surface grating couplers require costly active alignment/attach processes and are highly sensitive to thermo-mechanical displacements, there is an increasing drive in the market for disruptive low-cost and low-loss optical coupling technologies for packaging that can easily be scaled for mass production.

Accordingly, it would be desirable to establish packaging methodologies and techniques that allow optical interconnections to be implemented between silicon photonics devices, optical fibers, semiconductor devices, MOEMS etc. with low cost whilst offsetting the losses that arise from the manufacturing tolerances of passive packaging techniques.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to integrated optical components and more particularly to establishing structures and methods for packaging discrete integrated optical components and assembling integrated optical component sub-assemblies based upon photonic wire bonds and photonic wire bonding techniques.

In accordance with an embodiment of the invention there is provided a method comprising:
forming a pool comprising a bottom and a plurality of sidewalls;
disposing one or more liquids within a pool;
processing the one or more liquids with an illumination system to selectively cure or solidify a portion of the one or more liquids; wherein
the plurality of sidewalls of the pool retain the one or more liquids;
selectively curing or solidifying the portion of the one or more liquids generates a predetermined portion of an optical waveguide coupled at a first end to a first optical component and at a second distal end to a second optical component;
at least one of the first optical component and a substrate upon which the first optical component is integrated or mounted form a first sidewall of the plurality of sidewalls;
at least one of the second optical component and a carrier of the second optical component form a second sidewall of the plurality of sidewalls;
a third sidewall of the plurality of sidewalls is formed within the substrate; and
a fourth sidewall of the plurality of sidewalls is formed within the substrate.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic of a mechanical structure for the formation of a photonic wire bond (PWB) between an optical fiber within a U-or V-groove formed within a silicon substrate and an optical waveguide formed upon the silicon substrate according to an embodiment of the invention;

FIG. 2 depicts an optical micrograph of a PWB between an optical fiber within a U-or V-groove formed within a silicon substrate and an optical waveguide formed upon the silicon substrate according to an embodiment of the invention;

FIG. 3 depicts a schematic of a mechanical structure for the formation of a photonic wire bond (PWB) between an optical fiber within a U- or V-groove formed within a silicon substrate and an optical waveguide formed upon the silicon substrate according to an embodiment of the invention;

FIG. 4 depicts an optical micrograph of PWB interconnections between a pair of optical fibers and a pair of optical waveguides according to an embodiment of the invention;

FIG. 5 depicts a schematic of an alternate design according to an embodiment of the invention for mounting an optical fiber in a U-groove with movable ratcheted platforms retaining the ends of the optical fibers and accommodating length variations in arrays of optical fibers;

FIG. 6 depicts an optical micrograph of a PWB test die as described and depicted in FIG. 3, optically interfaced to a ribbon-fiber array of optical fibers;

FIGS. 7 and 8 depict optical micrographs of a silicon substrate test die incorporating test structures for optical fiber attachment and PWB interfaces between optical waveguides and optical fibers;

FIG. 9 depicts an optical micrograph of a PWB implemented to taper from an optical fiber to an intermediate mode profile and then taper back to another optical fiber;

FIG. 10 depicts computer aided design (CAD) images for a mechanical structure facilitating a PWB between an optical waveguide and a semiconductor device according to an embodiment of the invention;

FIG. 11 depicts a schematic of a mechanical structure supporting the formation of a photonic wire bond (PWB) between an optical fiber within a U-or V-groove formed within a silicon substrate and a facet of an optical semiconductor device mounted formed upon a carrier according to an embodiment of the invention;

FIG. 12 depicts an optical micrograph of an assembled optical emitter - optical fiber assembly as depicted schematically in FIG. 11;

FIG. 13 depicts a schematic of a chip-on-carrier optical emitter with a micromachined silicon block retaining an optical fiber upon a common carrier as supported by embodiments of the invention;

FIG. 14 depicts plan view schematics of two designs of micromachined silicon block for retaining an optical fiber according to embodiments of the invention;

FIG. 15 depicts CAD images of a test structure for formation of PWBs between optical waveguides, optical fibers and semiconductor devices together with silicon photonic test structure die employing the test structure according to embodiments of the invention;

FIG. 16 depicts an optical micrograph of the PWB test structure mounted to a carrier wherein an optical fiber has been interconnected to one optical waveguide at the edge of the substrate and therein to a PWB transitioning between the optical waveguide and a semiconductor optical amplifier; and

FIG. 17 depicts an optical micrograph of a photonic wirebond between an optical waveguide upon a photonic integrated circuit (PIC) and a discrete semiconductor device (e.g. laser diode or semiconductor optical amplifier).

### DETAILED DESCRIPTION

The present invention is directed to conventional integrated optics microelectromechanical systems (IO-MEMS) by integrated optics MEMS (IO-MEMS) concepts and more particularly to establishing butt coupling and gap closing of waveguides in IO-MEMS to improve upon the state of the art for the designs of optical switches, optical component packaging, optical coupling and stress compensated component manufacturing.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front,” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

Within the prior art, see for example U.S. Pat. No. 8,903,205 entitled “Three-Dimensional Freeform Waveguides for Chip-Chip Connections”, optical waveguide structures (referred to a photonic wire bonds or PWBs) are described which are formed from one or more materials which can be processed with a high-resolution, three-dimensional structuring technique to generate optical waveguides that can be directly optically connected or optically connected via special connecting structures from one optical waveguide (e.g. an optical fiber or integrated optical waveguide) to another optical waveguide (e.g. an optical fiber or integrated optical waveguide). The inventors have established methods and embodiments for the optical interconnection between two optical waveguides, e.g. an optical fiber and a silicon photonic waveguide (e.g. silicon nitride photonic waveguide), an optical fiber and an edge emitting semiconductor device, an edge emitting semiconductor device (e.g. a LD, semiconductor optical amplifier (SOA)) and a silicon photonic waveguide, a silicon photonic waveguide to a semiconductor device, or an optical waveguide and a MOEMS device.

Within the following description photonic wire bonds are described and presented as bring formed through a direct lithography process within a liquid photosensitive materials to generate the waveguide core wherein through controlled positioning and movement of the incident beam(s) of light three-dimensional (3D) optical waveguides (waveguides) which are self-supporting can be generated. The inventors refer to these waveguides as being free-form waveguides as the geometry and/or position of the waveguide can be defined based upon factors including computer aided design (CAD), optical simulations, and the physical positions of the optical elements to which the PWB interfaces at either end.

Accordingly, the PWBs can support mode field diameter (MFD) conversion and matching position along these PWBs (interconnection links) between independent optical circuits components such as singlemode or multimode optical waveguides (e.g. optical fiber waveguides referred to as optical fibers within this specification) and/or planar integrated waveguides of different material systems and designs, referred to as integrated optical waveguides or simply waveguides within this specification such as two-dimensional (2D) or planar waveguides and 3D or channel waveguides as referred to in the art.

Subsequent to placement of the two optical elements to be connected with the PWB a PWB manufacturing system employing automated moving stages and/or positioning arms in combination with image processing and pattern recognition algorithms locates the waveguide cores, for example, of the optical elements being interconnected and then locally prints the photonic wire bonds, referred as they function as an optical/photonic equivalent between waveguide cores to be interconnected as do electrical wirebonds between electrical structures to be interconnected. This process provides low-cost, low-loss optical interconnections within production-friendly embodiments that are scalable for mass-volume production.

Importantly, the integration of a photonic wire bond between waveguides provides for a defined and repeatable alignment between the waveguides such that the PWB can “absorb” mismatches arising from manufacturing tolerances which would otherwise either lead to high insertion losses or increased costs of manufacturing to achieve tighter manufacturing tolerances.

However, it would be evident to one of skill in the art that other direct write or additive manufacturing technique may be employed to generate the PWB(s) without departing from the scope of the invention. Further, whilst the light based methodologies, such as two-photon polymerization, described and depicted exploit what the inventors refer to as a “pool” of the light sensitive material(s) to form the waveguide core it would be evident that within other embodiments of the invention alternate deployment means for a liquid selectively cured material may be employed such as controlled micro-dispensing etc. Further, other optical (i.e., non-UV) or non-electrical techniques may be employed to “cure” the liquid. “Curing” may for example be through cross-linking, optically induced polymerization etc. Optionally, two or more beams may be employed to “write” the PWB wherein each beam is at an intensity insufficient to trigger the transition in the material from liquid to solid but the overlapping point of these beams has sufficient intensity to trigger the transition. Optionally, a single beam may be employed with a very shallow focal depth such that in the unfocussed regions the power density is insufficient to trigger the transition in the material from liquid to solid but the focal point has sufficient power density to trigger the transition.

Optionally, it would be evident that other than direct write techniques such as additive manufacturing techniques may be employed without a “pool” of material. For example, WO/2018/145,194 entitled “Methods and Systems for Additive Manufacturing” describes techniques referred to as Selective Spatial Solidification to form a 3D piece-part directly within a selected build material whilst Selective Spatial Trapping “injects” the build material into a manufacturing system and selectively directs it to accretion points in a continuous manner.

Within the following sections exemplary PWB interconnections are described with respect to the interconnection of different optical elements/optical waveguides. It would be evident to one of skill in the art that the PWB interconnection designs and methodologies as described may be applied to other optical interconnections either discretely or in combination without departing from the scope of the invention.

### A: Silicon Nitride Waveguides to Single-Mode Fiber Coupling via Photonic Wire Bond

Within this section the specific context of writing a photonic wire bonding link between an optical fiber and an integrated photonics silicon nitride waveguide is described and presented. However, it would be evident that in order to provide a fixed and repeatable alignment between an optical fiber and a silicon nitride waveguide core allowing the implementation of automated photonic wire bonding writing recipes essential to mass-production schemes requires that the optical fiber(s) be positioned/retained in a similarly automated/mass production manner.

Accordingly, the inventors have worked to develop custom U-groove structures formed within 200 mm (8 ″) diameter silicon-on-insulator (SOI) wafers where the thickness of the top silicon slab is engineered to make the optical fiber cores co-planar and co-axial with the silicon nitride waveguide cores to which they to be coupled. Descriptions with respect to such structures are described and depicted within WO/2020/093136 entitled “Structures and Methods for Stress and Gap Mitigation in Integrated Optical Microelectromechanical Systems.”

Accordingly, within embodiments of the invention U-grooves are etched into a top silicon slab using any suitable anisotropic patterning process(es), such as Deep Reactive Ion Etching (DRIE) for instance, with a Buried Oxide (BOX) layer acting as an etch-stop to provide a repeatable etch depth. These U-grooves have their lengths, widths and depths engineered to tightly receive and host the stripped ends of optical fibers (e.g. 125 μm outer diameter singlemode optical fibers such as Corning SMF-28 for example), position them to within a specified tolerance (e.g. ±1um in vertical and lateral directions) from the axis of the silicon nitride waveguides whilst providing sufficient space for the controlled dispense and capillary-force driven infiltration of structural (and/or optical) UV (and/or thermally) curable adhesives to fix the optical fibers within the U-grooves. A controlled dispense is engineered to provide for both thermo-mechanical stability of the fiber in the U-Groove and for homogeneous embedding of the fiber in the surrounding adhesive which is key for reliable detection of the fiber core by the vision system of the photonic wire bonding tool. The U-Grooves lengths are also engineered to set a repeatable distance in the horizontal direction between the end facet of the optical fiber and the opposing silicon nitride waveguide.

However, the optical fibers may be fixed into position with other mechanisms such as metallized fiber/solder to metallization on the silicon substate or optical waveguide stack, attachment of a top-cover over the U-grooves and optical fibers etc.

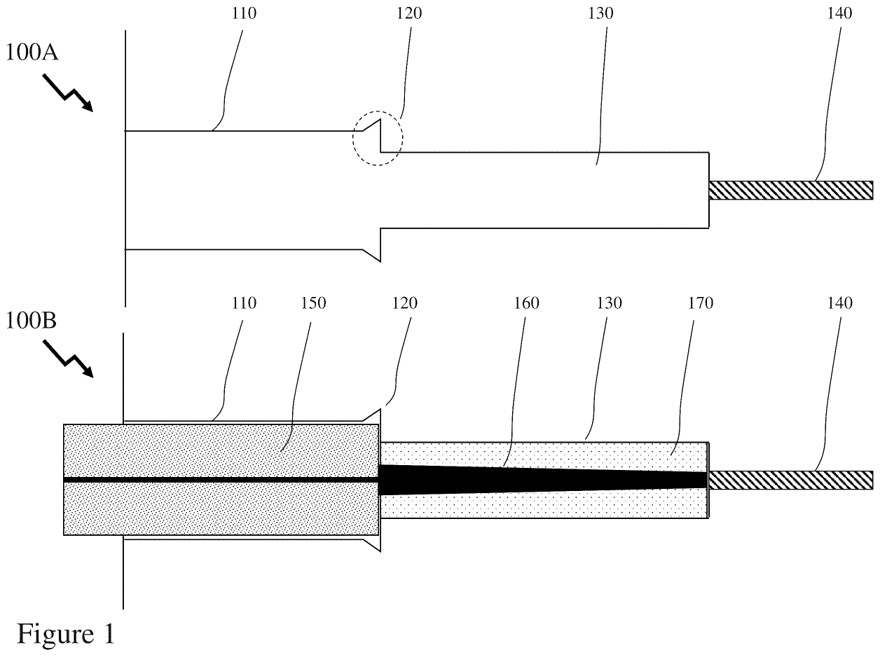

Within embodiments of the invention as depicted in FIG. 1 and described below the interface region between the U-groove structure(s) and the optical waveguide(s) comprises a customized receptacles (referred to as a pool by the inventors) such that this pool can be filled with one or more materials from which the PWB is formed is located between the optical fibers and the silicon nitride waveguides. These pools receive and contain, for example, a liquid photoresist from which the photonic wire bonding core is written with a direct write process. The dimensions of the pools provide for line-of-sight visual access of the PWB manufacturing system to the cores of the optical fiber and silicon nitride waveguide so that the vision system of the PWB writing tool can locate them and lock onto them. The dimensions of the pools provide for repeatable, sufficient, yet minimal volume of the photoresist to be dispensed and maintained in location to ensure a repeatable PWB writing process.

Referring to FIG. 1 there are depicted first and second Views 100A and 100B of an exemplary “pool” based PWB structure at initial photonic integrated circuit (PIC) manufacturing stage and after assembly with optical fiber and formation of the PWB respectively according to an embodiment of the invention. Accordingly, referring to first View 100A the optical interface portion of the PIC relating to U-groove/optical fiber/PWB is depicted showing the Optical Waveguide 140 of the PIC, the U-Groove 110 (or V-Groove or other structure to locate and retain an optical fiber), and the Pool 130 within which the liquid from which the PWB will be formed.

The Pool 130 is narrower than the U-Groove 110 such that a Butt Stop 120 is formed which enables for provisioning of a fixed and repeatable separation between the end facet of the optical fiber when inserted and the facet of the Optical Waveguide 140. The sidewalls of the Pool 130 have engineered sizes and shapes to allow for adequate line-of-sight visual access for the vision system to the optical fiber core whilst improving the control over the optical and/or structural liquid dispense by acting as mechanical and capillary stoppers. An exemplary embodiment of the invention being depicted in FIG. 1B.

The Butt Stops 120 as depicted are further patterned with, optional, structures which the inventors refer to as “butterfly structures” which enable removal of the rounded (in the instance of a U-Groove) bottom wall shapes typical of anisotropic patterning processes like DRIE, which would otherwise impede on proper core-core alignment between waveguides and optical fibers by causing the latter to lift as they are butted against the Butt Stop 120 (U-groove-to-pool separation sidewall).

Subsequently, as depicted in second View 100B the Optical Fiber 150 is inserted such that the end facet of the Optical Fiber 150 forms the fourth and initially missing wall of the pool for the liquid with the Pool 130. In this manner the liquid is dispensed into a region with sidewalls limited its flow where the properties of the liquid are such that capillary wicking of the liquid out into the U-Groove 110 is limited or avoided. However, in other instances, this wicking of the liquid may be employed to provide a curable adhesive layer between the silicon (or other material) substrate within which the U-Groove 120 is formed and the Optical Fiber 150. Optionally, the Optical Fiber 150 may be fixed into position within the U-Groove 110 prior to the formation of the PWB 160 between the end facet of the Optical Fiber 150 and the facet of the Optical Waveguide 140 or within other embodiments of the invention an overall curing of another material, Filler 170, employed to provide a cladding of the PWB 160.

Accordingly, the U-groove-pool-waveguide structure are implemented through a microfabrication process exploiting process and/or design building blocks/elements from a proprietary MEMS fabrication process of one applicant, see for example WO/2020/093136 entitled “Structures and Methods for Stress and Gap Mitigation in Integrated Optical Microelectromechanical Systems.” Accordingly, the U-Groove-Pool and U-Groove-Pool-Waveguide alignments are established by design and are hardcoded onto microfabrication photomasks thereby established repeatability of lateral and longitudinal geometry aspects whilst those vertical to the plane of the U-Groove-Pool-Waveguide are established through the design of the optical waveguide stack, underlying stack elements (e.g. BOX), silicon wafer etc. and processing tolerances and/or integration of etch stops etc.

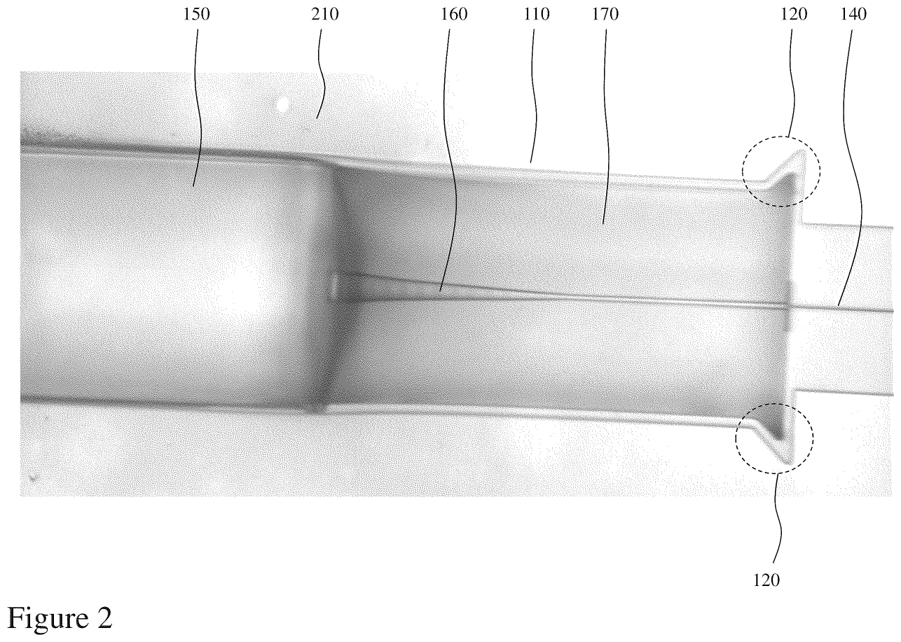

An optical micrograph of a variant design of a PWB between an optical fiber within a U-or V-groove formed within a silicon substrate and an optical waveguide formed upon the silicon substrate according to an embodiment of the invention is depicted in FIG. 2. FIG. 2 depicting the final assembled interface such that depicted are the Silicon Substrate (Si-Substrate) 210, U-Groove 110, Optical Fiber 150 and Optical Waveguide 140. Also depicted are PWB 160 between the end facet of the Optical Fiber 150 and the facet of the Optical Waveguide 140 and Filler 170. However, in contrast to FIG. 1 the Butt Stops 120 (also referred to as “butterfly structures”) are now at the facet of the etched Si-Substrate 210 where the Optical Waveguide 140 terminates. As noted above these Butt Stops 120 or butterfly structures enable removal of the rounded (in the instance of a U-Groove) bottom wall shapes typical of anisotropic patterning processes like DRIE employed in the manufacturing process. In this instance, whilst the Butt Stops 120 are not engaged against the end of the Optical Fiber 150 there ensures a vertical facet which would otherwise impede on proper core-core alignment between the Optical Waveguide 140 and PWB 160.

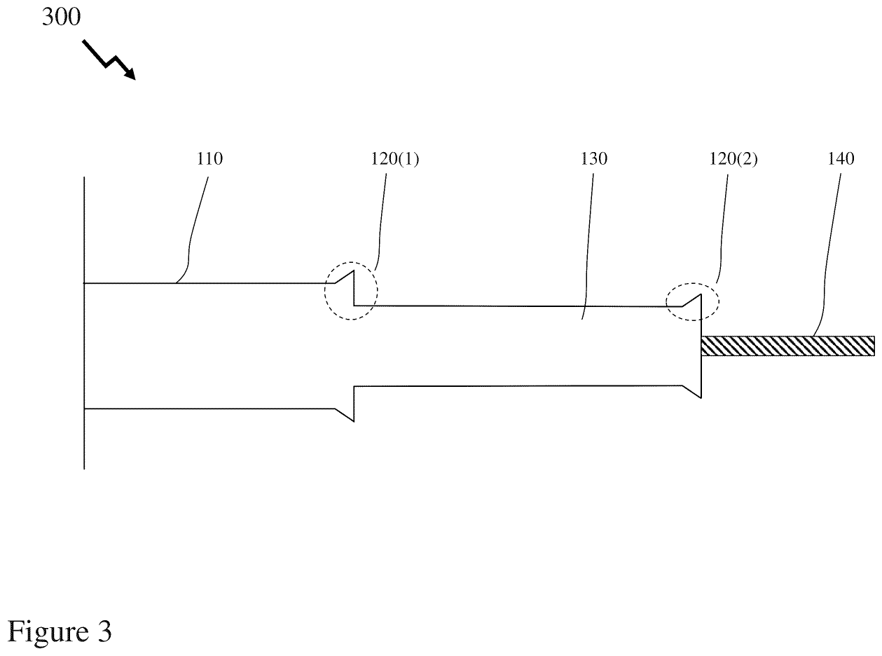

Referring to FIG. 3 there is depicted a Schematic 300A of an alternate design for the formation of a Pool 130 between the end of an optical fiber (not shown for clarity), which is inserted into the U-Groove 110 till it abuts the first Butt Stops 120(1) and the facet of the silicon at the end of the Optical Waveguide 140 where second Butt Stops 120(2) are formed to ensure that the manufacturing processes yield an appropriate facet for coupling the PWB (not shown for clarity) to the end of the Optical Waveguide 140. Whilst within FIG. 3 the first Butt Stops 120(1) and second Butt Stops 120(2) are depicted as having similar dimensions it would be evident that within other embodiments of the invention that these may have different dimensions and/or geometries.

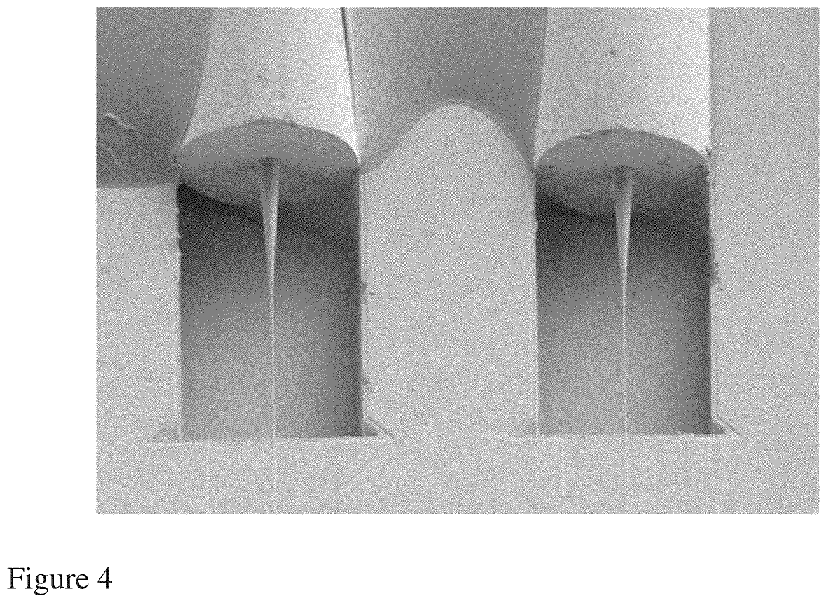

Now referring to FIG. 4 there is depicted an optical micrograph of a pair of optical fibers which are optically coupled to a pair of optical waveguides via a pair of PWBs. In contrast, to the optical micrograph in FIG. 2 it is evident that the Filler 170 has not been placed into the pool formed by the sidewalls of the U-groove, end facet of the silicon and the end fact of the optical fiber. Accordingly, FIG. 4 may, within some embodiments of the invention depict the scenario where the PWB is air-clad such that no Filler 170 is employed. Optionally, within other embodiments of the invention the PWB may be a core-clad structure without employing a Filler 170 as mechanical element. Optionally, within other embodiments of the invention FIG. 4 depicts the fabrication partly completed prior to the deposition and curing of the Filler 170 within the pool.

### B: Silicon Nitride Waveguides

Within exemplary embodiments of the invention the optical waveguides, e.g. Optical Waveguide 140 in FIG. 1, employed for the PICs and therein coupling to and/or from other optical elements with PWBs are based upon a 450nm thick Silicon Nitride (SiₓN_{y}, referred to subsequently as SiN for ease of reference) core symmetrically clad with 3.2 μm of Silicon Oxide (SiO₂) above and below. This material choice provides an advantage over waveguides with silicon cores in regard of PWBs because the lower core-clad refractive index contrast results in larger mode field diameters (MFD) than silicon waveguides. Larger MFDs allow for more overlap in the interconnection region, which results in increased tolerances with respect to misalignment between the PWB and the SiN cores to achieve low-loss optical links.

Within embodiments of the invention the SiN waveguide cores are patterned with tapers in the region close to the interface with the PWB taper in order to increase the MFD further, thereby providing an additional relaxation of the taper-to-taper alignment constraints and tolerances. Larger MFDs also allow for slightly larger PWB taper which, in turn, allows for relaxed process tolerances and associated improved repeatability. Within embodiments of the invention the SiN waveguide cores are patterned with square cross-section tapers in the region closest to the interface with the PWB taper in order to provide circularly symmetric mode fields with angular symmetry such that when coupled with photonic wire bonding cores with cylindrical symmetry, optical interfaces with low polarization sensitivity are produced.

Within embodiments of the invention the SiN waveguides between the PWB interfaces and the PIC/MOEMS etc. elements are implemented with low coupling efficiency (i.e. 1%) evanescent couplers to provide power taps located close to the PWB optical interface. These are typically implemented within the non-tapered section of the SiN waveguides. The output from these power taps are coupled to surface grating couplers, monolithically integrated photodiodes or other optical means for in-line monitoring of the quality and insertion losses of the PWB interfaces. Accordingly, once the PWB core has been formed then the optical performance of the PWB interface can be established prior to the PWB cladding material being dispensed and cured. This provides an opportunity within the workflow for a rework step before the cladding is implemented providing a non-reworkable PWB or a PWB with increased complexity/difficulty of removal. Such a re-work stage is implemented as a way to improve the yield of assembly processes whereby costly parts are mated through PWB to make up systems or sub-systems.

### C: Optical Fiber Attachment

Within exemplary embodiments of the PWB manufacturing system with Two Photon Polymerization based processing the optical performance of the PWB writing head provides a topological constraint whereby a maximum 250 μm height different can exist within a radius of 6 mm from the writing site. Typical processes whereby fibers are lowered into V-or U-grooves and attached which usually involves small permanent glass or ceramic slabs (referred to as lids) to press the optical fibers firmly onto the bottom of the grooves to favor core-to-core alignment in the vertical axis. Such glass or ceramic lids have typical thicknesses in the range of millimeters such that these are incompatible with the exemplary embodiments of the PWB writing tool and processes.

Accordingly, the inventors have established a fiber assembly/attachment process wherein the inventors process the optical fibers by cleaving, stripping (typically between 3-5mm (0.12″-0.2″) and then clamping them into a fiber manipulator. While hovering a few hundreds of microns above the U-groove surface, the fiber(s) are maneuvered until their free end is within about 30-50 μm (0.012-0.020″) from the sidewall between the U-groove and the PWB pool. They are then lowered into the U-groove and slipped laterally until they are flush or project from with the pool wall. Using a second manipulator, a temporary needle is pressed onto the fibers. Then, the fibers are moved back (250-300 μm (0.010-0.012″) and the structural adhesive is dispensed into the second closed receptacle along the MSB chip, for example ⅔ of the way along the MSB chip. Control of the dispensed adhesive quantity ensures complete coverage of the fiber surface lining the U-groove walls and makes sure the adhesive makes it up to the fibers tip facing the PWB pool, while not creeping onto the fiber facet. Typically, motion of the optical fiber(s) along the U-groove is 250-300 μm (0.010″-0.012″) although other distances may be employed depending upon the initial positioning of the optical fibers relative to the Butt Stops or other features employed to define the end-point of the optical fiber within the U-Groove.

Once the structural adhesive is dispensed, it is partially cured (for example using a UV flash cure for a UV curable material) to mechanically secure the assembly. A strain relief adhesive is added on the other side of the fibers in order to fix them mechanically. The temporary needle used to apply a force on the fibers is then removed. Full curing of the different resins, adhesives etc. is then undertaken. Solvents used for a develop step of the PWB photo-patterning process can be deleterious to some fiber jacket and buffer materials. To circumvent this problem the inventors have established a process outlined above wherein the optical fibers are stripped over a predetermined distance, the region at which the bare silica optical fiber transitions to being coated with the primary coating is sealed with a sealant, the bare silica optical fibers are inserted into the U-grooves, manipulated and secured, and the acrylate coated optical fibers are secured by means of a strain-relief (e.g. an adhesive) to a carrier of the die or package etc.

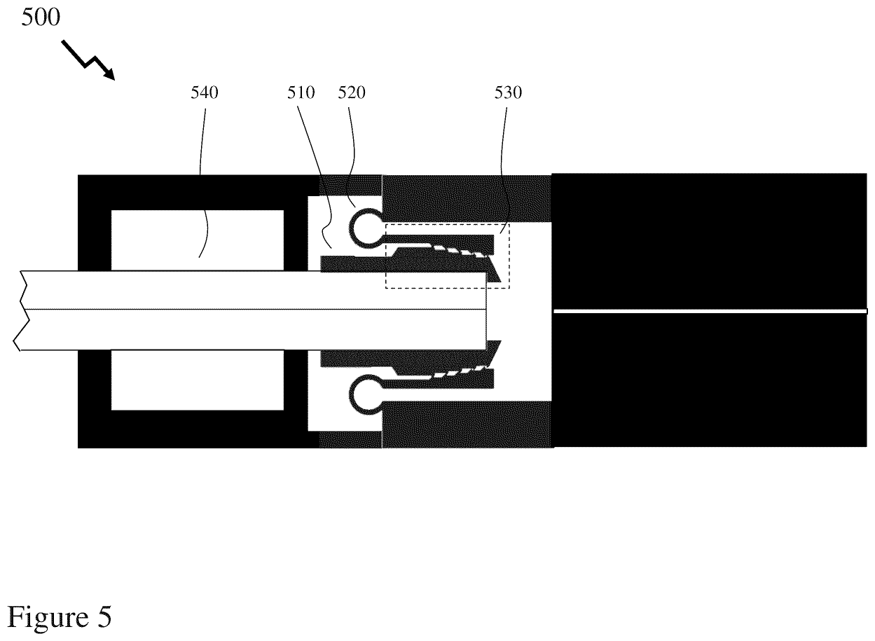

Within other embodiments of the invention the Butt-Stops may be replaced with suspended platforms which allow for accommodation of length variations within the cleaved fibers of a ribbon fiber or array of ribbons. The inventors refer to this as a flexible edge connection (FLEC) PWB interface. Accordingly, there is depicted a Platform 510 which abuts the end face of the optical fiber when the fiber is inserted into the U-groove or V-groove. In FIG. 5 the fiber end face abuts the Platform 510. Platform 510 are Ratchet Structures 530 which are coupled to the Si-Substrate via Hinges 520. Accordingly, movement of the optical fiber towards the optical waveguide (depicted on the right of FIG. 5 by the white line) once the optical fiber has abutted the Platform 510 ratchets the Platform 510 within the Ratchets 530. Accordingly, differences in lengths of adjacent fibers in an array of optical fibers are accommodated where the open ends of the Platforms 510 allow PWBs to be formed upon the end-face of the optical fibers. However, retention of the optical fibers within the U-grooves (or V-grooves) is now via Pools 540. Optionally, Butt Stops or butterfly structures may be integrated into the Platform 510.

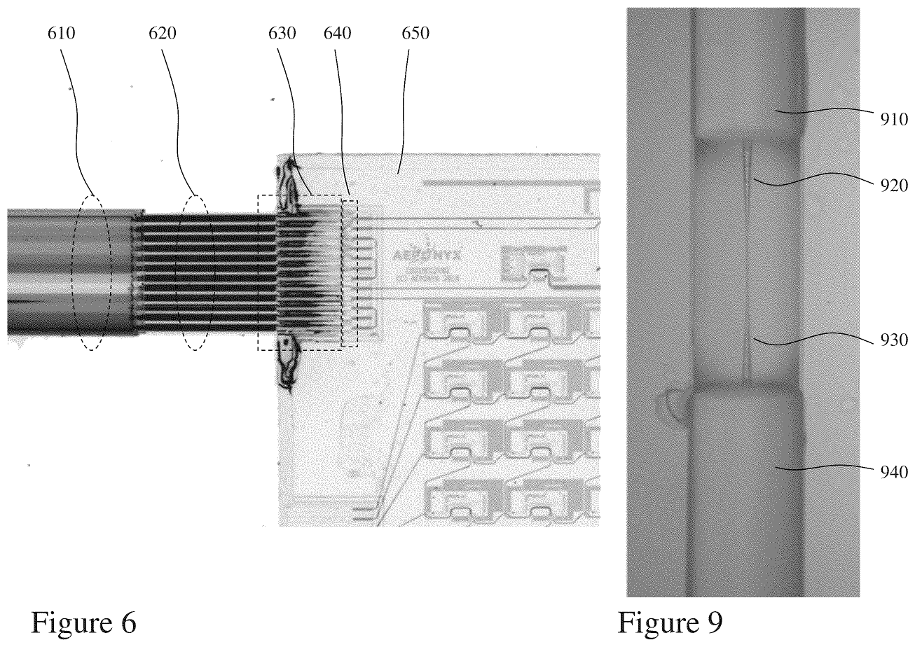

Referring to FIG. 6 there is depicted an inverted (negative) optical micrograph of a PWB Test Die 100G as described below in Section X and depicted in Figure X, optically interfaced to a Ribbon-Fiber Array 610 of optical fibers. As depicted the Ribbon-Fiber Array 610 transitions to a Stripped Region 620 where the coatings of the individual fibers within the Ribbon-Fiber Array have been removed too expose the outer cladding of each optical fiber. These have then been inserted in U-Grooves within Region 630 at the end of which is Pool Region 620 comprising an array of pools in Transition Region 640 within which the PWBs are or will be fabricated to couple to the optical waveguides upon the PWB Test Die 650.

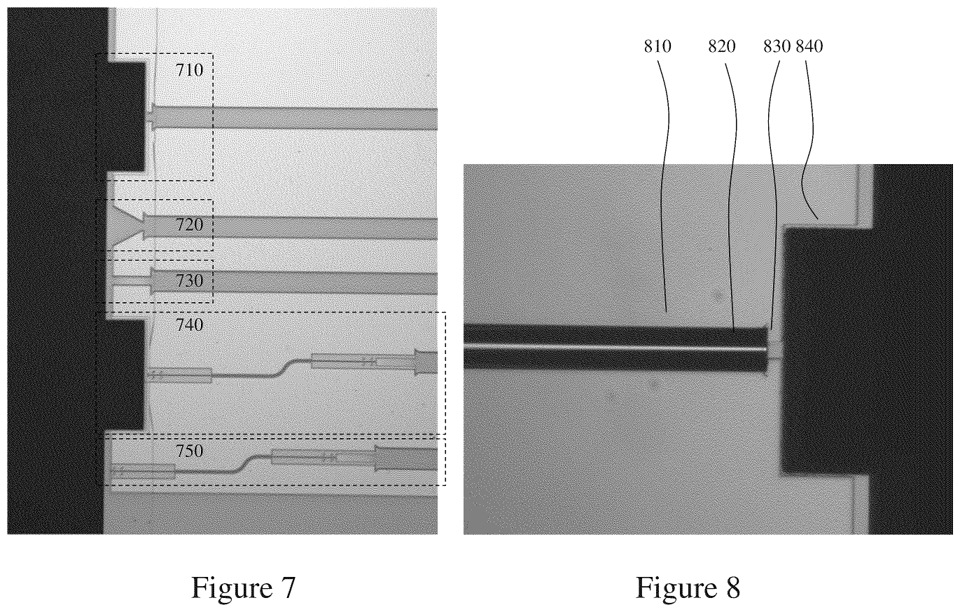

Now referring to FIG. 7 there is depicted an optical micrograph of a silicon substrate test die incorporating test structures for optical fiber attachment and PWB interfaces between optical waveguides and optical fibers. FIG. 7 depicts first to fifth Test Structures 710 to 750, these being:
First Test Structure 710 comprising a U-Groove from right to left with Butt Stops and Pool with an open trench at the edge of the die to allow optical microscopy of the assembled interface from the facet or wherein a PWB may be formed within the Pool for coupling to/from an optical semiconductor device die upon a carrier to which the Si-Substrate is also mounted;
Second Test Structure 720 comprising from right to left a U-Groove with Butt Stops and Pool of alternate “funnel” design wherein the Pool increases in width away from the Butt Stops wherein a PWB may be formed within the Pool for coupling to/from an optical semiconductor device die upon a carrier to which the Si-Substrate is also mounted;
Third Test Structure 730 comprising from right to left a U-Groove with Butt Stops and Pool of a design as depicted in FIG. 1 allowing a PWB may be formed within the Pool for coupling to/from an optical semiconductor device die upon a carrier to which the Si-Substrate is also mounted;
Fourth Test Structure 740 comprising a U-Groove with Butt Stops and Pool of a design as depicted in FIG. 1 allowing a PWB may be formed within the Pool for coupling from/to the optical waveguide wherein the end of the optical waveguide terminates at an open trench at the edge of the die to allow free-space coupling to/from the optical waveguide via a lens or other optical assembly;
fifth Test Structure 750 essentially as per fourth Test Structure 740 but without the trench at the edge of the Si-Substrate.

Now referring to FIG. 7 there is depicted an optical micrograph of an assembled first Test Structure 610 in FIG. 6 where an Optical Fiber 720 has been inserted into the U-Groove 710 where the Pool 730 and Trench 740 are evident.

This physical step is therefore an extension of the U-groove floor without any sidewall. It serves as a platform to easily position a needle and dispense a structural adhesive droplet or droplets that will then creep (wick) along the part of the fiber inserted in the U-groove. Control of the dispensed adhesive quantity ensures complete coverage of the fiber surface lining the U-groove walls and makes sure the adhesive makes it up to the fiber tip facing the PWB pool, whilst not creeping onto the fiber face. This particular configuration of adhesive, fiber clad and core materials allows for optimal detection conditions that are essential for the writing tool's vision system and enables the automated/repeatable processes. Once the structural adhesive is dispensed, it is cured using a UV exposure to mechanically secure the assembly. The temporary needles, or other means to position and retain the optical fibers into the U-grooves (or V-grooves) are then removed and discarded.

Solvents used for a develop step of the PWB photo-patterning process can be deleterious to some fiber jacket and buffer materials. To circumvent this problem the inventors have established a process wherein:
the optical fibers are stripped over a predetermined distance (e.g. 1 mm, 3 mm, or 5 mm (0.04″, 0.12″, or 0.20″)) from their cleaved end, upon which the PWB is formed, such that the primary coating (e.g., 242 μm±5 μm diameter acrylate for SMF-28 single mode fiber) begins at a distance beyond the edge of the die;
the region at which the bare silica optical fiber transitions to being coated with the primary coating is sealed with a sealant;
the bare silica optical fibers are inserted into the U-grooves, manipulated and secured; and °the acrylate coated optical fibers are secured by means of a strain-relief (e.g. an adhesive) to a carrier of the die or package etc.

The sealing of the exposed primary coating of the optical fiber employs a material which is resistant to the materials employed in the securing of the optical fibers into the U-grooves and the strain-relief securing the optical fibers to the carrier or package etc. This is primarily the solvents or elements of the different material employed which have high mobility, e.g. via the phenomenon known as wicking or accidental splashing, spillage etc. Accordingly, the sealing material in combination with the structural and strain relief adhesives dispensed can prevent migration of any solution(s)/solvent(s) along the fiber with their subsequent interaction with or trapping by the coating(s) of the optical fiber during the PWB processing sequence. These migrated solution(s)/solvent(s) if trapped or reacting with the coating(s) of the optical fiber and/or other materials in the final packaged component may yield degradations in performance over time impacting reliability and/or leading to failures in qualification testing etc.

### D: Photonic Wire Bond Waveguides

One of the advantages of the Photonic Wire Bond technology is that the PWB optical waveguides can be adapted to the desired mode field diameter (MFD) commensurate with the wavelengths of interest, provided it is previously well known and characterized. As the PWB is formed through a direct write or additive manufacturing processes then the design of the PWB does not have to be constant and it can vary from one end to the other such that the PWB can interfaced to and optically connect waveguides and/or devices with differing MFDs together by means of proper engineering of the PWB taper diameter and its variation along the propagation axis. Within embodiments of the invention the inventors have established optimized transitions between mode size conversion sections of the PWB whereby tapered sections of different diameters and lengths are facing each other with the shortest possible straight, fixed diameter sections in between. This allows for shorter, lower loss interconnections to implement compact integrations. Referring to FIG. 9 there is depicted an optical micrograph of a PWB implemented to taper from a first optical waveguide 910 (in this instance an optical fiber) to an intermediate mode profile and then taper back to a second optical waveguide 940 (in this instance another optical fiber). Accordingly, the PWB comprises a first PWB taper 920 and a second PWB taper 930. It would be evident that within some embodiments of the invention to minimize design variants that a PWB from a first waveguide to a second waveguide may transition through a pair of tapers wherein the first taper adjusts the mode geometry a first geometry coupled to the first waveguide to a defined intermediate geometry and the second tapers adjusts the mode geometry from the defined intermediate geometry to a second geometry coupled to the second waveguide. Accordingly, within an embodiment of the invention the first taper couples from SMF-28 to a reduced mode size whilst the second taper adjusts the mode from circular to elliptical for example such that with varying optical waveguide designs it is only the second taper that is adjusted. Alternatively, the defined intermediate geometry may be larger than either of the modes at either end of the PWB.

### E: Edge Coupled Semiconductor Device to Optical Fiber Interconnect/Packaging.

As a result of development activities through which several concepts were trialed and developed the inventors have established a specific configuration whereby a silicon die with a specific thickness is provided within which a U-Groove of specific depth and specific shape is implemented thereby presenting a pocket or pool of specific dimensions enables capabilities with respect to implementing packaging of an edge coupled semiconductor device (EC-SD). This edge coupled semiconductor device may be a laser diode (LD), distributed feedback LD (DFB LD), semiconductor optical amplifier (SOA), superluminescent light emitting diode (SLED), waveguide photodetector etc. Accordingly, the advantages of the design methodology established by the inventors provide for self-alignment of the optical fiber within the carrier and the carrier itself with the EC-SD carrier, with respective heights “z” of the interfaces well defined within the tolerances of the PWB process.

In the specific context of writing a PWB between an optical fiber and an edge-emitting semiconductor laser chip or laser PIC, one must again provide for a fixed and repeatable alignment between the optical fiber facet and the laser waveguide facet that will allow the implementation of automated photonic wire bonding writing recipes essential to mass-production schemes. The challenge with edge emitting lasers is that they consist of standalone die, having dimensions from 0.16×0.15×0.8 mm³ for discrete distributed feedback (DFB) laser die up to 0.5×3.0×0.15 mm³ for multi-electrode PIC lasers for example. These die must be positioned precisely to allow the fibers and the lasers waveguides to come in close proximity (250-300 mm) along the light propagation axis (commonly referred to as the x-axis) and to within 50 mm in the lateral and vertical axes perpendicular to the propagation axis (commonly referred to as the y-axis and z-axis respectively). The light exits the lasers with a specified direction relative to the facet normals and from a specified z distance from a reference surface and centered to topographic features such as trenches or alignment marks. The shape of the lasers optical mode may be elliptical, as in case of low cost/high yield ridge waveguide (RWG) lasers or nearly circular, as in case of more complex buried heterostructure (BH) devices equipped with waveguide tapers and/or spot size converters.

Since each PWB written is in direct contact with the laser facet these are coated with anti-reflection layers adapting the laser waveguide effective index to that of the PWB waveguide, at the lasers operating frequency or frequencies. Further, the die should be placed such that the emitted optical radiation is orientated relative to the other element the PWB is interconnecting to, e.g. an optical fiber, to facilitate manufacturing of the PWB and a PWB design with minimum three-dimensional structure apart from that necessary to provide for any mode transition from the PWB end coupled to the laser to the other end coupled to the other element. Whilst the ensuing descriptions and comments above are directed to laser diodes or other optical emitters it would be evident that the same requirements exist when considering waveguide based optical photodetectors and whilst not explicitly described the techniques, designs, methods and processes may be applied to these as well.

Accordingly, the inventors have established a design and manufacturing methodology for edge emitting laser chips whereby the laser die are initially mounted on a first type of carrier and then co-packaged onto a second type of common carrier with a micromachined silicon blocks opposing them within which the optical fiber is retained. Accordingly, for example, a laser die is assembled onto a first type of carrier, an optical fiber assembled with a micromachined silicon block and then the first type of carrier and the micromachined silicon block are assembled onto a second type of carrier to fix the two elements and the PWB written. Optionally, within embodiments of the invention the second type of carrier may integrate the micromachined silicon block (i.e. be formed in silicon) or may provide the same functionality as the micromachined silicon block, i.e. have a U-groove, V-groove, rectangular groove etc. for retaining the optical fiber, a region for the pool, and an attachment location for the laser die upon the first type of carrier. Whilst the designs described and depicted below in respect of edge-emitting devices (or edge-absorbing devices such as waveguide-based photodetectors) are presented with respect to a single optical channel it would be evident that whilst not explicitly described the techniques, designs, methods and processes may be applied to arrayed edge emitters and optical fiber arrays. Accordingly, for example, a laser die with multiple lasers may be assembled onto a first type of carrier, an optical fiber array assembled with a micromachined silicon block and then the first type of carrier and the micromachined silicon block are assembled onto a second type of carrier to fix the two elements. Then the multiple PWBs are written. Optionally, within embodiments of the invention the second type of carrier may integrate the micromachined silicon block (i.e. be formed in silicon) or may provide the same functionality as the micromachined silicon block, i.e. have U-grooves, V-grooves, rectangular grooves etc. for retaining the optical fibers, regions for the pools, and an attachment location for the laser die upon the first type of carrier. Within the following description the techniques, designs, methods and processes are described with respect to a laser but may be applied to waveguide photodetectors, laser PICs, or PICs within a different material system to one integrated upon silicon (e.g. those based upon InP semiconductor alloys, GaAs semiconductor alloys, polymers, etc.).

### E1: Laser Chip-on-Carrier

The first type of carrier (herein after first carrier or laser carrier) onto which the laser chip or PIC is integrated is a thermally conductive substrate (e.g. >18 W/m·K) with suitable coefficient of thermal expansion (CTE) for reliable operation of the laser, and appropriate surface metallization patterns to allow for laser die bonding and local electrical Au wire bonding to the laser pads for biasing and operation. This first carrier may be any suitable type of substrate such as the top surface of a thermoelectric controller, or more generally any thermally conductive substrate with CTE closely matched to the laser substrate CTE (e.g. InP, GaAs, etc.). It can be a ceramic, a metal alloy or a metal composite substrate. The carrier may be flat or equipped with standoffs either machined or formed during forming of the carrier such as through ceramic green-tape stacks which are co-fired.

The laser is typically mounted such that the emitting edge is coincident with the carrier edge (flush mount) or projects slightly although it may within embodiments of the invention be recessed from the carrier edge. However, semiconductor laser chips being often designed with an intentional angular offset of a few degrees to mitigate interfacial reflections such that the emitted beam is not perpendicular to the laser die facet and accordingly the die is mounted at a corresponding angle on the carrier with a variable amount of overhang (or recess) on the carrier whereby the emitting edge extends beyond (or backs behind) the carrier edge by a distance between 0 -100 mm.

However, beneficially, the PWB technology allows for an integration scheme agnostic of the presence of an angled facet, hence allowing for flexible laser chip implementation choices or retrofittable integrations. The thickness of the carrier is engineered to make the laser waveguide co-planar with, and in some instances co-axial with, the optical axis of the other element (e.g. optical fiber core) considering factors such as the thickness of the optical element, core location, adhesives/solder/metallization etc. used to attach the laser carrier chip and the micromachined silicon block on the common carrier. Whilst offsets can be accommodated the design for a nominal zero offset reduces the three-dimensional spatial geometry of the PWB to that providing the requisite mode size transformation(s) and adjustment(s).

The semiconductor laser chip is attached to its carrier in such a way that topographic features and/or alignment marks or other visual features) used for optical detection by the PWB writing tool system are facing the PWB writing tool vision system. Therefore, the laser is bonded with its p-side up in case of lasers grown on a n-type substrate. In case of a flip chip laser with coplanar contacts (lasers grown on semi-insulating substrates or n-type substrate), the laser is bonded with its co-planar n and p contacts up, with topographic features visible to the PWB writing tool. The laser chip-on-carrier components (such as thermistors, termination capacitors and resistors, and internal wire bonds loops etc.) are selected and assembled such that they do not violate any maximum height limit above the lowest point between the laser waveguide output and the fiber core center in order to prevent interference with the PWB writing tool during the PWB writing process.

### E2: Micromachined Silicon Block and Pools

The micromachined silicon block (hereinafter referred to as the MSB) is designed to receive the fiber and the optical/structural adhesives for attachment. In essence it is a discrete element such as described above for accepting an optical fiber without any PIC as the other end of the PWB is now going to be the laser die.

For example, the MSB may be fabricated from a 200 mm silicon-on-insulator (SOI) wafer whereby the total thickness and the thickness of the top silicon slab are engineered to make the optical fiber cores co-planar and co-axial with the laser waveguide to which they are matched. These thicknesses are engineered in consideration of the mounting used to attach the laser carrier chip and of the micromachined silicon block to the common carrier, e.g. adhesive, resin, solder, cold-weld, etc. The lateral dimensions of the fiber block are established to allow compact common lateral co-packaging together with the laser chip-on-carrier (CoC) on the common carrier. Physical dimensions may be determined within some embodiments of the invention by the constraints of a pick-and-place robotic system employed to assemble the MSB onto the common carrier. The U-groove(s) (or V-grooves etc.) are etched into the top silicon slab using any suitable anisotropic patterning process, such as Deep Reactive Ion Etching (DRIE) for instance, with a Buried Oxide (BOX) layer acting as an etch-stop guaranteeing repeatable etch depths for a fiber mechanical stop. The U-grooves have lengths, widths and depths engineered to tightly receive and host stripped ends of optical fibers. They may be adapted to standard 125 μm fiber diameter or reduced fiber diameters such as 80 μm for example. The U-grooves may also be engineered to introduce a controlled vertical offset of a few tens of microns to improve yield repeatability and efficiency.

This design leaves enough space for the controlled dispense and capillary-force driven infiltration of a structural adhesive to attach the optical fiber(s) to the MSB, this being for example an optically and/or thermally curable adhesive or adhesives. The controlled dispense is engineered for maximum infiltration coverage to provide for both thermo-mechanical stability of the optical fiber in the U-Groove and for homogeneous embedding of the fiber in the surrounding adhesive which is key for reliable detection of the fiber core by the vision system of the photonic wire bonding tool.

The U-Grooves lengths may also be engineered to set a repeatable distance in the light propagation axis (x) between the optical fiber cores and the opposing laser waveguide cores or to accommodate length variations when cleaving ribbon fibers.

The MSB may also comprise a first custom-sized open-ended receptacle, located between the optical fiber and the opposing laser COC. These receptacles, once adjoined to and pushed against the laser chip-on carriers define the pools are meant to receive and contain the liquid photoresist in which the PWBs are written. Optionally, the first custom-sized open-ended receptacle may be upon the laser CoC or portions of the receptacle may be implemented upon the MSB and laser CoC respectively. Optionally, the receptacle may comprise a portion of the carrier to which the MSB and laser CoC respectively are attached together other portions from the MSB and/or laser CoC respectively. Accordingly, in any configuration the receptacle when formed from its different elements defines the pool to receive and contain the liquid photoresist in which the PWB or PWBs are written.

The dimensions of the pool for each device design engineered to accept and accommodate laser chips overhanging at an angle or straight from their carrier whilst allowing for line-of-sight visual access to the cores of the optical fiber and laser waveguides so that the vision system of the PWB writing tool can locate and lock onto them. The dimensions of each pool are also established to provide for repeatable, sufficient, yet minimal volume of photoresist (or whatever material is employed for forming the PWB core) to be dispensed and maintain it in location to ensure a repeatable PWB writing process. The pool design also provides for removal of the photoresist (or other material) at the develop stage after writing of the PWB waveguide core.

Finally, the micromachined silicon block comprises a second closed receptacle or sub-pool located inside the MSB chip. This second pool or sub-pool may, for example, be located two-thirds of way along the MSB chip. This sub-pool is intended to provide easy access to the adhesive dispense needle, receive, and control the quantity of structural/optical adhesive distributed to the U-groove. Once the structural adhesive(s) are cured, the sub-pool can later receive a strain relief adhesive to further strengthen the optical fiber assembly.

### E3: Common Carrier and C0-Packaging

As mentioned above, the laser chip-on-carrier (CoC) and the micromachined silicon block (MSB) are co-packaged onto a second common carrier. This common carrier can be a thermally conductive ceramic, silicon, a top surface of a thermoelectric controller, or other suitable material or materials having the requisite mechanical, thermal and electrical properties. The surface can include alignment marks for precision assembly of the CoC and/or PWB. The MSB is aligned, adjoined, and pushed against the laser CoC to define the retention pool for the PWB material(s). These two parts are held in place using thermally conductive, thermally cured adhesive dispensed prior to positioning on the carrier. The thickness of the adhesives as well as the respective thicknesses of the MSB and the laser carrier are engineered to maintain a repeatable separation between the facet of the optical fiber and the laser waveguide, for example 250-300 μm (0.01-0.12″). This distance is established to allow sufficient mode field diameter conversion distance and minimize adiabatic optical losses while maintaining low propagation losses of the PWB. The various thicknesses of the MSB and CoC etc. are also engineered to result in a systematic small height offset between the optical fiber core and the laser waveguide, for example 10-20 μm (0.004″-0.008″), to allow for a curved PWB, e.g. what is commonly referred to as S-shaped. This PWB geometry allows for accommodating differential thermal displacements between the MSB and laser CoC. Finally the thickness engineering provides for sufficient clearance for the PWB tool's optical column objective to have room to operate.

### E4: Fiber Attach

As noted above the optical column of the PWB writing head has tight topological constraints whereby a maximum of 250 μm height difference (0.01″) (z-delta) may exist within a radius of 6 mm from the writing site. However, it would be evident that different PWB writing heads may provide different topographical constraints to these. However, the following description applies albeit with different physical boundaries.

Typical processes whereby fibers are lowered into V-or U-grooves and attached usually involve small permanent glass or ceramic slabs (lids) to press the fibers tightly into the bottom of the grooves to favor core-to-core alignment in the vertical axis. Such glass or ceramic lids have typical thicknesses which are unsuited for the PWB writing systems employed by the inventors. Thin slabs may suffer breakage or deform.

Within an embodiment of the invention the inventors process the optical fibers by cleaving, stripping (typically between 3-5mm (0.12″-0.2″) and then clamping them into a fiber manipulator. While hovering a few hundreds of microns above the U-groove surface, the fiber(s) are maneuvered until their free end is within about 30-50 μm (0.012-0.020″) from the sidewall between the U-groove and the PWB pool. They are then lowered into the U-groove and slipped laterally until they are flush or project from with the pool wall. Using a second manipulator, a temporary needle is pressed onto the fibers. Then, the fibers are moved back (250-300 μm (0.010-0.012″) and the structural adhesive is dispensed into the second closed receptacle along the MSB chip, for example 2/3 of the way along the MSB chip. Control of the dispensed adhesive quantity ensures complete coverage of the fiber surface lining the U-groove walls and makes sure the adhesive makes it up to the fibers tip facing the PWB pool, while not creeping onto the fiber facet.

Once the structural adhesive is dispensed, it is partially cured (for example using a UV flash cure for a UV curable material) to mechanically secure the assembly. A strain relief adhesive is added on the other side of the fibers in order to fix them mechanically. The temporary needle used to apply a force on the fibers is then removed. Full curing of the different resins, adhesives etc. is then undertaken. Solvents used for a develop step of the PWB photo-patterning process can be deleterious to some fiber jacket and buffer materials. To circumvent this problem the inventors have established a process outlined above wherein the optical fibers are stripped over a predetermined distance, the region at which the bare silica optical fiber transitions to being coated with the primary coating is sealed with a sealant, the bare silica optical fibers are inserted into the U-grooves, manipulated and secured, and the acrylate coated optical fibers are secured by means of a strain-relief (e.g. an adhesive) to a carrier of the die or package etc.

The sealing of the exposed primary coating of the optical fiber employs a material which is resistant to the materials employed in the securing of the optical fibers into the U-grooves and the strain-relief securing the optical fibers to the carrier or package etc. This is primarily the solvents or elements of the different material employed which have high mobility, e.g. via the phenomenon known as wicking or accidental splashing, spillage etc. Accordingly, the sealing material in combination with the structural and strain relief adhesives dispensed can prevent migration of any solution(s)/solvent(s) along the fiber with their subsequent interaction with or trapping by the coating(s) of the optical fiber during the PWB processing sequence. These migrated solution(s)/solvent(s) if trapped or reacting with the coating(s) of the optical fiber and/or other materials in the final packaged component may yield degradations in performance over time impacting reliability and/or leading to failures in qualification testing etc.

### E5: Photonic Wire Bond Waveguides

An important aspect of Photonic Wire Bond technology is the ability for the PWB to adapt its mode field profile (mode field diameters in both x and z directions)to another optical waveguide provided that the optical mode field diameter (MFD) is known and characterized. The PWB by appropriate design can therefore be easily used to optically connect waveguides and/or devices of differing MFDs and ellipticity together by means of proper engineering of the PWB taper diameter and its variation along the propagation axis of the PWB. Further, design flexibility in materials and cladding can be exploited to enhance this provided that the material(s) for the core can be selectively written in three-dimensions by an appropriate PWB writing (or generating tool). Whilst the embodiments of the invention are described with respect to resists or adhesives/resins that are curable under ultraviolet (UV) illumination it would be evident that similar direct write can be implemented with visible light, infra-red light, far infra-red light etc. as well as other non-optical techniques such as electron-beam irradiation for example.

The longitudinal dimension of the pool (assuming the two optical waveguides to be interfaced are aligned along it) is established by the design of the PWB and accordingly its length and shape to balance the tradeoffs of sufficient distance to allow for efficient mode field diameter conversion with low adiabatic optical losses and low propagation loss. An optimization also considers the MSB and laser CoC positioning tolerances onto the common carrier.

Within some embodiments of the invention the PWB may be air clad or partially air clad (i.e. over a predetermined portion of its length where a high index contrast optical waveguide is required) whilst within other embodiments of the invention one or more PWB cladding materials may be employed that cover both the PWB core and the mating interfaces to the optical components, e.g. optical fiber and laser. allows for intrinsic passivation and encapsulation of the optical coupling link, providing for tolerance to variable ambient conditions.

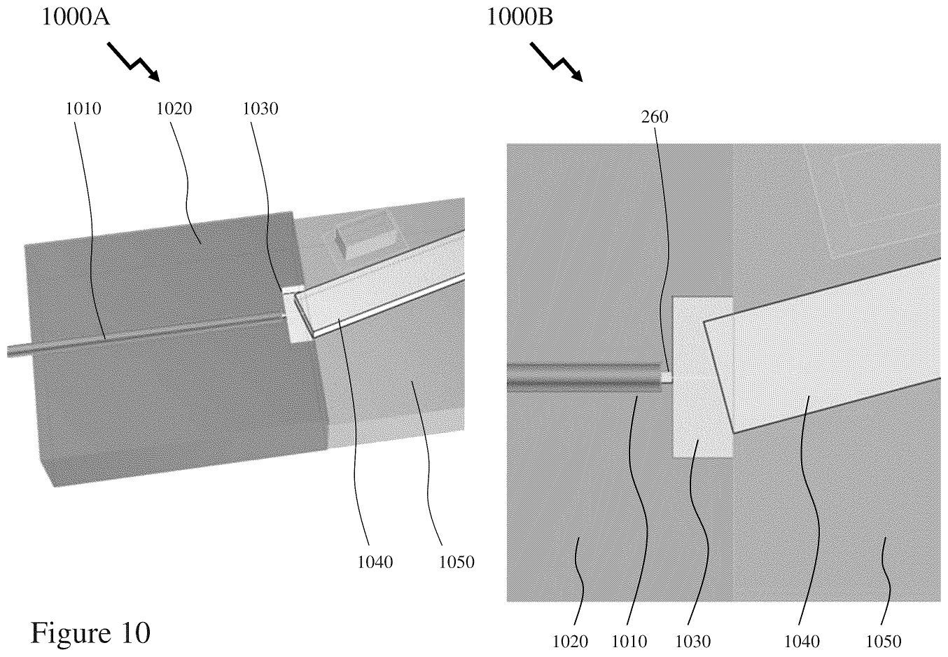

Referring to FIG. 10 there is depicted a schematic of a MSB and laser CoC assembly absent the common carrier beneath prior to the formation of the PWB. For example, referring to first Image 1000A the optical axis of the Optical Fiber 1010 within the U-Groove (not identified for clarity) on the MSB 1020 is aligned with the optical axis of the optical waveguide upon the Edge Coupled Semiconductor Die (EC-SD) 1040, e.g. a DFB laser die or InP PIC, which is mounted to the CoC 1050. The end of the MSB 1020 having a Pool 1030 for containing the liquid for forming the PWB to interconnect the Optical Fiber 1010 to the EC-SD 1040. The CoC 1050 and MSB 1020 being mounted to a common carrier (not depicted for clarity). This interface region between the CoC 1050 and MSB 1020 forming the Pool 1030 is depicted in more detail in second Image 1000B in FIG. 10.

The special shape of the End 1060 (edge) of the U-Groove, a short region of reduced width relative to the U-groove provides for placement of the Optical Fiber 1010 by butting the facet of the Optical Fiber 1010 to the End 1060 with a predetermined “x” displacement from the edge of the Pool 1030 therein provided well defined positioning of the Optical Fiber 1010 core. Within FIG. 10 the EC-SD 1040 is depicted with its facet overhanging the edge of the CoC 1040 such that the facet of the EC-SD 1040 projects into the Pool 1030.

As discussed above the U-Groove enables a structural glue dispense under and on the side of the Optical Fiber 1010 to the U-Groove for attaching the Optical Fiber 1010 to the MSB 1020.

The special “butterfly” shape (see for example Butt Stop 120 in FIG. 1, also referred to as a “butterfly” structure by the inventors) on the edge of the U-Groove combined with appropriate structural glue dispense enables a self-contained pool for the liquid used in the PWB, that enable low consumption of chemicals and very stable conditions for the PWB writing. Moreover, as the objective of the lithography optics is moved in axial direction during the writing step, the pool prevents excess movement of the resist which could potentially disturb the writing process.

Within another embodiment of the invention the MSB 1020 and CoC 1050 are the same carrier wherein either the design of the U-Groove is modified in order to raise the core of the Optical Fiber 1010 into axial alignment with the waveguide of the EC-SD 1040 or the region upon which the EC-SD 1040 is assembled is etched to lower the EC-SD 1040 relative to the CoC 1050.

The integration of the fiber directly into the U-groove of the chip allows for a leveled surface with no parts higher than the working distance of the lithography system forming the PWB.

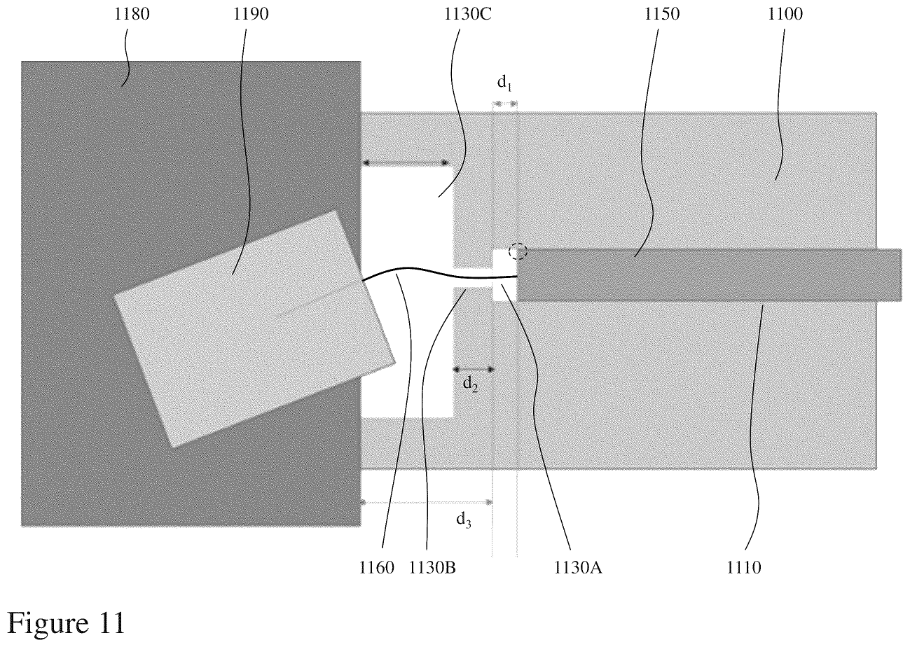

Referring to FIG. 11 there is depicted a schematic of a mechanical structure supporting the formation of a photonic wire bond (PWB) between an optical fiber within a U-or V-groove formed within a silicon substrate and a facet of an optical semiconductor device mounted formed upon a carrier according to an embodiment of the invention. Accordingly, as depicted an Optical Fiber 1150 is mounted within a U-Groove 1110 (or a V-groove or other recess having a defined cross-section) formed within a MSB 1100 (e.g. silicon). The Optical Fiber 1150 abuts an end of the U-Groove 1110 where the pool begins, this being defined by a first Pool Section 1130A which begins where the interface between the U-Groove 1110 and first Pool Section 1130A comprises Butt-Stops 1120 as described above in respect of FIG. 1 which may or may not comprise “butterfly structures.”

The first Pool Section 1130A transitions to a second Pool Section 1130B and therein to a third Pool Section 1130C. Each of the first Pool Section 1130A, second Pool Section 1130B, and third Pool Section 1130C being formed within the MSB 1100. The lengths of these sections of the pool being d₁, d₂, and d₃ respectively. An Edge-Coupled Semiconductor Device (EC-SD) 1190 mounted upon a CoC 1180 which is positioned to abut the end of the third Pool Section 1130C. Accordingly, the EC-SD 1190 and CoC 1180 form a fourth wall of the pool whereas the sidewalls of the first Pool Section 1130A, second Pool Section 1130B, and third Pool Section 1130C form another pair of sidewalls of the pool whilst the end of the Optical Fiber 1150 forms the final sidewall of the pool within which the liquid(s) are disposed for the formation of the PWB Core 1160 and/or PWB cladding.

The PWB provides an optical “bridge” between the Optical Fiber 1150 and the emitting or absorbing region (optical facet) of the facet of the EC-SD 1190 which transitions from a first mode field diameter (MFD) of the Optical Fiber 1150 to a second MFD of the optical facet of the EC-SD 1190. The dimensions of the first Pool Section 1130A, second Pool Section 1130B, and third Pool Section 1130C are established in dependence upon several factors, including the dimensions of the two optical elements being interconnected, providing a clear field of view for the optical imaging system used to acquire the locations for the ends of the PWB, and providing clear access for the illumination system employed to form the PWB core and/or cladding. The dimensions may also depend upon whether one or both ends are coupling to angled interfaces etc. In other embodiments of the invention these aspects may be modified if the MSB 1100 allows optical imaging system and the illumination system to access different sides of the MSB 1100.

Where the optical imaging system and illumination system are optically based then the MSB 1100 must be transparent or have low attenuation in the applicable wavelength range(s). However, in other instances with non-optical illumination for forming the PWB this requirement may be modified such that the MSB 1100 is transparent or has low attenuation for the non-optical illumination system for forming the PWB whereas the optical imaging system does not view through the MSB 1100.

Within FIG. 11 the dimensions of second Pool Section 1130B are smaller, at least laterally, than the first Pool Section 1130A and second Pool Section 1130C as the optical imaging system does not require access to these regions. Once the locations of the ends of the PWB are defined then the path of the PWB is defined by a processing system that then controls the illumination system forming the PWB and/or a positioning system upon which the CoC 1180 and MSB 1100 are mounted via a sub-carrier, package, etc. Accordingly, within other embodiments of the invention the pool may comprise a single section, two sections, four sections or more. Further, the lateral width and depth of each section may vary rather than being constant.

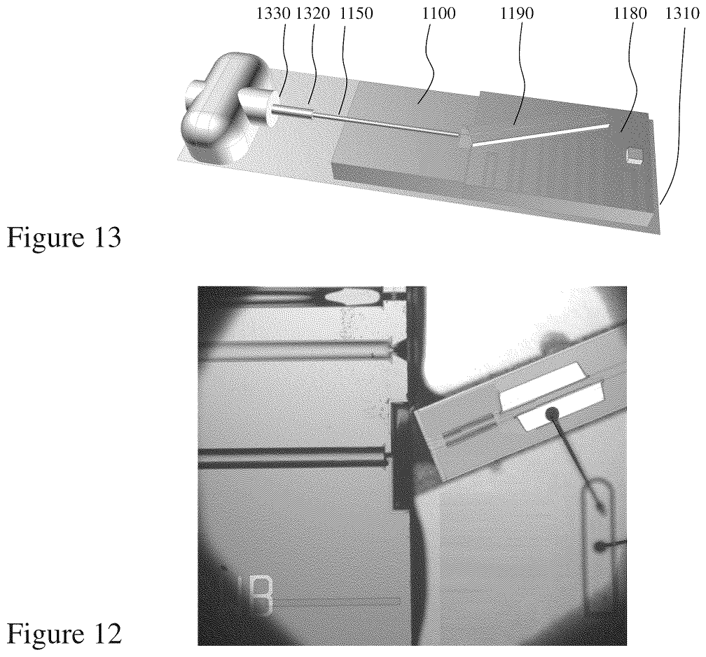

Now referring to FIG. 12 there is depicted an optical micrograph of an assembled optical emitter—optical fiber assembly as depicted schematically in FIG. 11. The optical fiber within the MSB on the left hand side is assembled within a first Test Structure 710 as described and depicted in respect of FIG. 7.

Referring to FIG. 13 there is depicted a schematic of a chip-on-carrier (CoC) optical emitter with a micromachined silicon block (MSB) retaining an optical fiber upon a common carrier as supported by embodiments of the invention. Accordingly, there is depicted the CoC 1180 with EC-SD 1190 on the right mounted to Common Carrier 1310. Disposed adjacent to the left of the CoC 1180 and also mounted to the Common Carrier 1310 is MSB 1100 with Optical Fiber 1150. The Optical Fiber 1150 is the core-cladding of diameter 125 μm or 80 μm for example. The Optical Fiber 1150 transitions to first Region 1320 where the Optical Fiber 1150 is clad with a primary coating, e.g. an acrylate, before transitioning to second Region 1330 wherein the outer body of the cable within which the Optical Fiber 1150 is disposed is depicted.

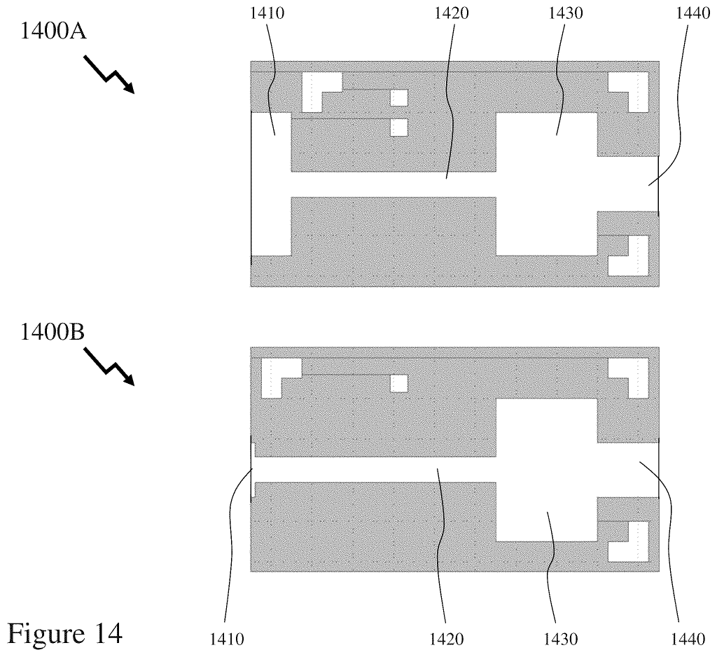

Now referring to FIG. 14 there are plan view schematics of two designs of micromachined silicon block (MSB) for retaining an optical fiber according to embodiments of the invention. First Schematic 1400A depicts a MSB with U-groove 1420, pool 1410 for abutting to a CoC, the integrated pool (or sub-pool as described above) 1430 within which the adhesive to retain the optical fiber is disposed and second U-groove 1440 which is dimensioned to support the primary coating of the optical fiber. Second Schematic 1400B depicts the same structure with a smaller pool 1410 for use, for example, when the remainder of the pool forms part of a CoC.

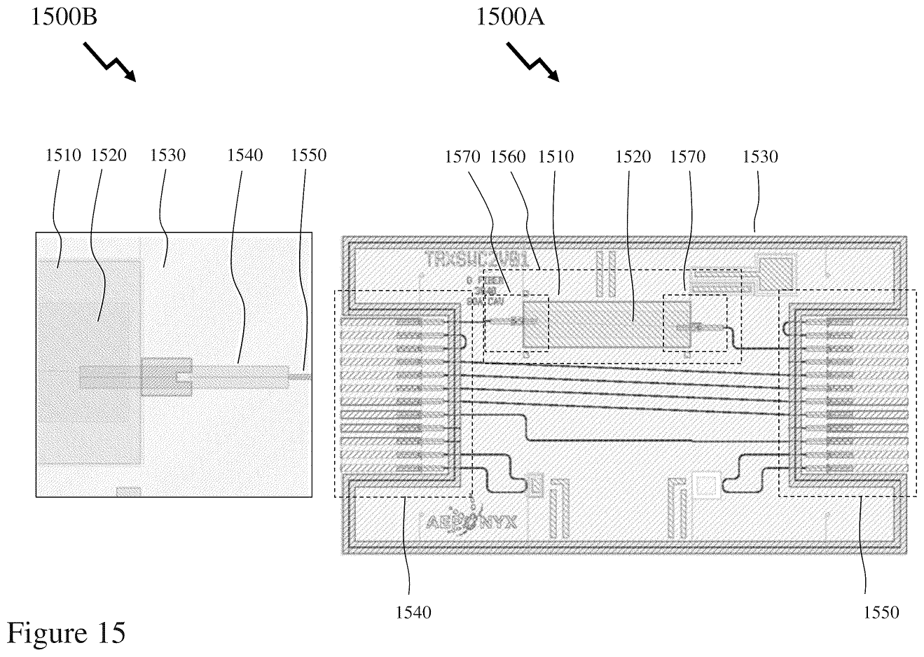

Referring to FIG. 15 there is depicted in first Image 1500A a CAD design for a test die on a Substrate 1530 for PWB interconnections between optical fibers and optical waveguides (e.g. first and second Regions 1540 and 1550) either in loop-back or through configurations together with an EC-SD Region 1560. Within EC-SD Region 1560 a Pocket 1510 within which is disposed an EC-SD 1520 having input and output Waveguide Coupling Regions 1570 which are depicted in detail in second Image 1500B. As depicted in second Image 1500B a Pocket 1510 is formed within a Substrate 1530 (e.g., silicon) within which is disposed the EC-SD 1520. The Optical Waveguide 1550 abut a Pool 1540 which extends to the Pocket 1510. The Pocket 1510 being, for example, a specifically design U-Groove within an embodiment of the invention.

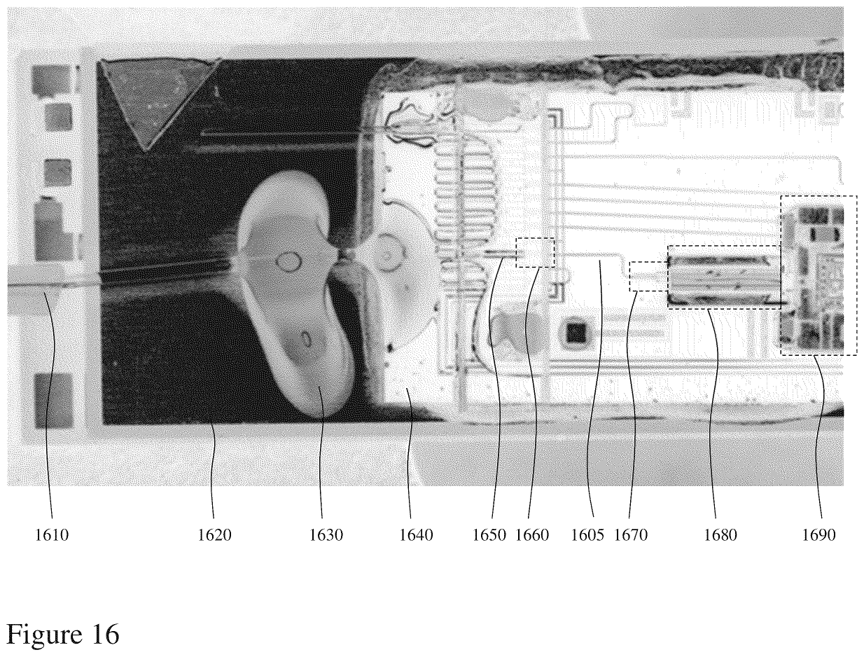

Referring to FIG. 16 there is depicted an optical micrograph of the PWB test structure mounted to a carrier wherein an optical fiber has been interconnected to one optical waveguide at the edge of the substrate and therein to a PWB transitioning between the optical waveguide and a semiconductor optical emitter (SOA). In contrast to the test die depicted in FIG. 3 the output of the SOA is coupled to a photodetector. Accordingly, in FIG. 16 there is depicted:
Optical Waveguide 1605;
Optical Fiber 1610;
Carrier 1620;
Retaining Epoxy 1630 retaining the Optical Fiber 1610 to the Carrier 1620;
Silicon Die 1640;
Optical Fiber in U-Groove 1650;
First PWB Transition 1660;
Second PWB Transition 1670;
Semiconductor Optical Amplifier (SOA) 1680; and
Chip-on-Carrier (CoC) Detector 1690.

The first PWB Transition 1660 comprises a PWB transitioning from the Optical Fiber 1610 within a U-Groove to the Optical Waveguide 1605. The second PWB Transition 1670 comprises a PWB transitioning from the Optical Waveguide 165 to the optical waveguide upon the SOA 1680. The CoC Detector 1690 comprises a sub-carrier onto which are mounted the photodetector and a transimpedance amplifier (TIA).

Accordingly, the concepts described above and depicted with respect to FIGS. 10-14 provide for:
Low complexity assembly process to enable easy PWB writing between laser and fiber.
An assembly process assembly that accommodates for EC-SD overhang by butting the EC-SD and its carrier (also referred to as a chip-on-carrier or CoC) to the die with the optical fiber.
Maintenance of an optical fiber at a specific distance and height.
Assembly with a CoC on a common platform, enabling the optical fiber interface and CoC to be on a common carrier, e.g. a thermoelectric cooler (TEC).
Writing of a PWB with minimal capillary force.
Controlled adhesive flow (through design of U-groove and capillary action) and stoppage of flow of adhesives (effect of restriction at the end).

### F: Edge Coupled Semiconductor Device Hybrid Integration

As a result of development activities through which several concepts were trialed and developed the inventors have established a specific configuration whereby PWB integration with both facets of an EC-SD, e.g. an SOA, is implemented. The underlying integration concept relates to using a common design of a specific pocket/pool/cavity for either interfacing an optical fiber with an EC-SD (e.g. a Group III-Group V SOA (referred to as a III-V SOA) such as a GaAs or InP based SOA) or an optical waveguide with an EC-SD (e.g., between an optical waveguide and a III-V SOA).

In the specific context of writing a PWB between an optical waveguide forming part of a PIC and an edge-emitting semiconductor laser chip or laser PIC, one must again provide for a fixed and repeatable alignment between the optical waveguide and the laser waveguide facet that will allow the implementation of automated photonic wire bonding writing recipes essential to mass-production schemes. The challenge with edge emitting lasers is that they consist of standalone die, having dimensions from 0.16×0.15×0.8 mm³ for discrete distributed feedback (DFB) laser die, through 0.40×1.00×0.10 mm³ semiconductor optical amplifier die, up to 0.5×3.0×0.15 mm³ for multi-electrode PIC lasers for example. These die must be positioned precisely to allow the optical waveguides and the lasers waveguides to come in close proximity (250-300 mm) along the light propagation axis (commonly referred to as the x-axis) and to within 50 mm in the lateral and vertical axes perpendicular to the propagation axis (commonly referred to as the y-axis and z-axis respectively). Whilst the following description is focused to a single interface, e.g. an interface between a laser diode and PIC or interface of a SOA to PIC (where the other port of the SOA is coupled to an external optical fiber via an embodiment of the invention or other prior art means) the principles may be extended to either interface of a semiconductor die coupled to optical waveguides at one end of a PIC, to a semiconductor die coupled between two PICs or to a semiconductor die inserted into a recess or cavity within a PIC.

### F1: Design Methodology

Accordingly, the inventors have developed a custom micromachined silicon hybrid integration methodology comprising four different structures:
U-Grooves to host incoming and/or outgoing fibers for optical input/output;
A first set of receptacle cavities to serve as pools for the PWB material in the fiber area;
A second set of receptacle cavities to serve as pools for the PWB material in the edge emitting device (EED) area; and
A third set of cavities to host and align the edge emitting devices.

These four structures are fabricated using a dual etch depth process whereby the U-Grooves and the two sets of pools share the same depth. The cavities for the EED(s) receive an additional etch to reach a different depth.

Within an exemplary embodiment of the invention the U-groove structures are fabricated in 200 mm silicon-on-insulator (SOI) wafers whereby the thickness of the top silicon slab is engineered to make the optical fiber cores co-planar and co-axial with the silicon nitride waveguide cores to which they are matched. The U-grooves are etched into the top silicon slab using any suitable anisotropic patterning process, such as Deep Reactive Ion Etching (DRIE) for instance, with a Buried Oxide (BOX) layer acting as an etch-stop guaranteeing repeatable etch depths for a fiber mechanical stop. The U-grooves have lengths, widths and depths engineered to tightly receive and host stripped ends of optical fibers. Width and depth are adjusted to position the nominal core(s) of the optical fiber(s) within ±1 μm in y and z axes from the axis of the PIC waveguide(s), e.g. silicon nitride waveguide(s). The U-grooves can be adapted to standard 125 μm diameter fibers or reduced diameter fibers having an outer cladding diameter of 80 μm for example although other diameters can be accommodated if required. The U-grooves can also be engineered to introduce a controlled vertical offset of a few tens of microns to improve yield repeatability and efficiency. This design leaves enough space for the controlled dispense and capillary-force driven infiltration of structural (and/or optical) UV (and/or thermally) curable adhesives. The controlled dispense is engineered for maximum infiltration coverage to provide for both thermo-mechanical stability of the fiber in the U-Groove and for homogeneous embedding of the fiber in the surrounding adhesive which is key for reliable detection of the fiber core by the vision system of the photonic wire bonding tool.

The U-Grooves lengths are also engineered to set a repeatable distance in the light propagation axis (x) between the optical fiber cores and the opposing silicon nitride waveguide cores. The U-groove ends can be further patterned with butterfly structures, such as described above in respect of FIG. 1, to eliminate rounded bottom wall shapes typical of anisotropic patterning processes like DRIE, which would otherwise impede on proper core-core alignment between waveguides and optical fibers by causing the latter to lift as they are butted against the U-groove-to-pool separation sidewall. Where ribbon fiber interconnects are employed other structures such as the platforms described and depicted in FIG. 5 may be employed.

The U-groove structures also comprise a first set of custom-sized receptacles/cavities (referred to as pools by the inventors), located between the facets of the optical waveguides being coupled together via the PWB(s). These pools receive and contain the liquid photoresist in which the PWB cores are to be written. The dimensions of the pools allows for line-of-sight visual access to the cores of the optical waveguide(s) and/or visual markers so that the vision system of the PWB writing tool can locate and lock onto them. The size of the first set of pools is also adapted with respect to the viscosity of the material deployed to allow for capillarity forces whilst ensuring repeatable, sufficient, yet minimal volume of photoresist to be dispensed and maintained in location to ensure a repeatable PWB writing process. The pool design also allows for easy removal of the photoresist at the develop stage of the PWB manufacturing process (when a resist or similar material is employed) and the uncured material is removed to allow for either air cladding or insertion of another material to form the cladding of the PWB.

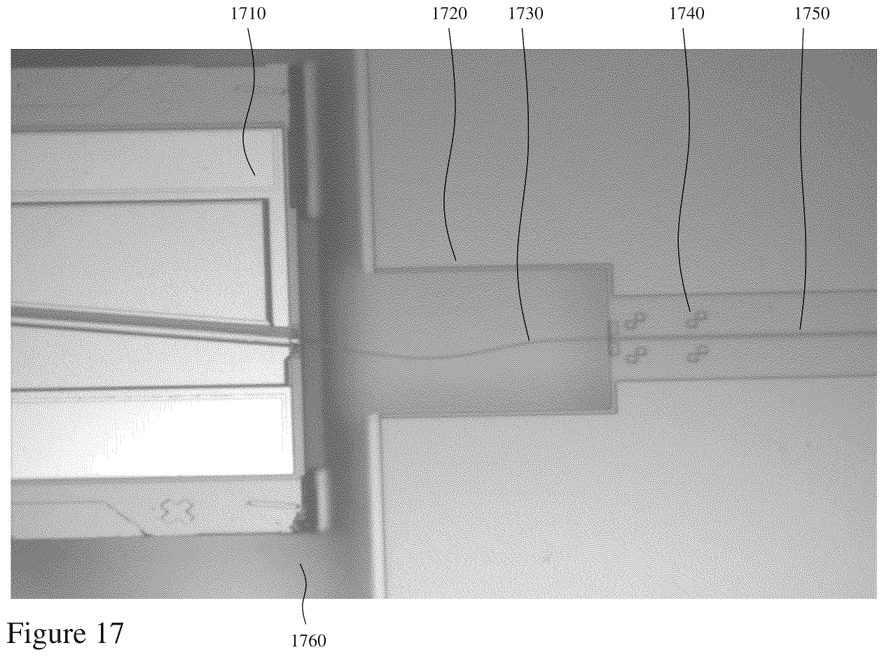

The first set of pools are separated from the U-grooves by sidewalls acting as butt stops enabling fixed and repeatable distances between optical fibers and waveguide cores that also account for fiber size tolerances. The sidewalls have engineered sizes and shapes to allow for adequate line-of-sight visual access for the vision system of the PWB writing system to image capture the optical cores, visual markers etc. whilst improving the control over the optical and/or structural adhesive dispense by acting as mechanical and capillary stoppers. However, where the optical interconnect is a PIC waveguide to EED waveguide the first set of pools may be eliminated as evident from FIG. 17.

The second set of receptacle cavities, or pools, receive and contain the liquid photoresist in which the PWB cores to the EED are to be written. The size of second set of pools allows for line-of-sight visual access to the cores of the silicon nitride and the EED waveguides so that the vision system of the PWB writing tool can locate and lock onto them. The size of the second set of pools also allows to adapt the viscosity and the capillarity forces for repeatable, sufficient, yet minimal volume of photoresist to be dispensed and maintained in location to ensure a repeatable PWB writing process. The sides of the second set of pools facing the EED are open ended such that PWB material may spill into the second deeper cavity, however the dead volume of the latter has been engineered to be minimal to avoid superfluous material consumption. The design of this second set of pools allows for easy removal of the photoresist at the develop stage.

The depth of the third set of cavities is engineered such that the edge emitting device waveguide core is co-axial and/or co-planar with the PIC waveguide core, e.g. silicon nitride waveguide core(s). The third set of cavities have a depth established by considering the thickness of the EED, that of the adhesive (e.g. thermally conductive epoxy), solder etc. holding it in place, and the required clearance for the PWB tool's optical column objective to have sufficient room to operate. The lateral size of the cavity is engineered to minimize the escape volume of PWB material as it spills out from the second set of pools while leaving enough space for the gripping effectors to maneuver the EED into position in the cavity if the EED is fixed into position after the second set of pools are filled.

### F2: Photonic Wire Bond Waveguide

An important aspect of Photonic Wire Bond technology is the ability for the PWB to adapt its mode field profile (mode field diameters in both x and z directions) to another optical waveguide provided that the optical mode field diameter (MFD) is known and characterized. The PWB by appropriate design can therefore be easily used to optically connect waveguides and/or devices of differing MFDs and ellipticity together by means of proper engineering of the PWB taper diameter and its variation along the propagation axis of the PWB. Further, design flexibility in materials and cladding can be exploited to enhance this provided that the material(s) for the core can be selectively written in three-dimensions by an appropriate PWB writing (or generating tool). Whilst the embodiments of the invention are described with respect to resists or adhesives/resins that are curable by two photon polymerization it would be evident that similar direct write can be implemented with visible light, infra-red light, far infra-red light etc. as well as other non-optical techniques such as electron-beam irradiation for example.

The longitudinal dimension of the pool (assuming the two optical waveguides to be interfaced are aligned along it) is established by the design of the PWB and accordingly its length and shape to balance the tradeoffs of sufficient distance to allow for efficient mode field diameter conversion with low adiabatic optical losses and low propagation loss. An optimization also considers the MSB and laser CoC positioning tolerances onto the common carrier.

Within some embodiments of the invention the PWB may be air clad or partially air clad (i.e. over a predetermined portion of its length where a high index contrast optical waveguide is required) whilst within other embodiments of the invention one or more PWB cladding materials may be employed that cover both the PWB core and the mating interfaces to the optical components, e.g. optical fiber and laser. allows for intrinsic passivation and encapsulation of the optical coupling link, providing for tolerance to variable ambient conditions. In some embodiments of the invention the cladding material may be different at one end of the PWB to another end or multiple cladding materials may be employed with temporary “dams” to allow selective disposition/curing for example.

Referring to FIG. 17 there is depicted an optical micrograph of an assembled EED-PIC interface exploiting embodiments of the invention. Accordingly, there are depicted:
EED 1710;
Pool 1720 (i.e. a cavity of the second set of cavities);
PWB Core 1730;
Optical Fiduciary Markers 1740 on PIC die adjacent to the PIC waveguide being coupled to;
PIC Waveguide 1750;
Cavity 1760 (i.e. a cavity of the third set of cavities) within which the EED is mounted.

Accordingly, the design methodology provides for:
Self-alignment of the fiber or waveguide with the SOA, with respective heights “z” of the interfaces well defined within the tolerances of the PWB process, in line with the lithography/etch process;
The special form on the edge of the U-Groove enable butting and/or SOA placement with a predetermined “x” displacement needed for a good PWB writing;
The U-Groove enables to have a structural glue placement under (if an optical fiber is used) and on the side of the optical fiber;
As the objective of the lithography optics is moved in axial direction during the writing step, the pool prevents excess movement of the resist which could potentially disturb the writing process;
The integration of the fiber and/or SOA directly into the U-groove of the chip allows for a leveled surface with no parts higher than the working distance; and
The capability of the lithography/etch process to pre-align both sides with the EC-SD facets.

Accordingly, the design methodology provides for:
A common process assembly methodology to enable PWB writing between an EC-SD (e.g., SOA) and Optical Fiber or an EC-SD and waveguide;
By appropriate design the concept is compatible with p-up and p-down EC-SD components;
Maintain an optical fiber at a specific distance and height from the EC-SD in a manner common with an optical fiber - waveguide interface as described above in respect of FIG. 1;
Write a PWB with minimal capillary force; and
Controlled flow (effect of U-groove) and stop of flow of adhesives (effect of restriction at the end).

It would be evident to one of skill in the art that the design process and/or design space for the PWB is linked to the SiN process flow as this enables the taper design through lithography/etch process and in terms of decreasing losses by control of the waveguide stack thickness which relates through to the use of specific SOI wafers and processes.

Within the embodiments of the invention described supra in respect of embodiments of the invention optical waveguides exploiting a silicon nitride core with silicon oxide upper and lower cladding, a SiO₂—Si₃N₄ —SiO₂ waveguide structure has been described and depicted together with a silicon core and silicon nitride upper and lower claddings, a e waveguide structure. However, it would be evident that other waveguide structures may be employed including, but not limited to, silica-on-silicon, with doped (e.g. germanium, Ge) silica core relative to undoped cladding, silicon oxynitride, polymer-on-silicon, doped silicon waveguides. Additionally, other waveguide structures may be employed including vertical and/or lateral waveguide tapers and forming microball lenses on the ends of the waveguides via laser and/or arc melting of the waveguide tip. Further, embodiments of the invention have been described primarily with respect to the optical alignment of silicon-on-insulator (SOI) waveguides, e.g. SiO₂—Si₃N4—SiO₂; SiO₂—Ge:SiO₂—SiO₂; or Si—SiO₂, but it would be evident embodiments of the invention may be employed to coupled passive waveguides to active semiconductor waveguides, such as indium phosphide (InP) or gallium arsenide (e), e.g. a semiconductor optical amplifier (SOA), laser diode, etc. Optionally, an active semiconductor structure may be epitaxially grown onto a silicon IO-MEMS structure, epitaxially lifted off from a wafer and bonded to a silicon IO-MEMS structure, etc. However, it would be evident to one skilled in the art that the embodiments of the invention may be employed in a variety of waveguide coupling structures coupling onto and/or from waveguides employing material systems that include, but not limited to, SiO₂—Si₃N₄—SiO₂; SiO₂—≥:SiO₂—SiO₂; Si—SiO₂; ion exchanged glass, ion implanted glass, polymeric waveguides, InGaAsP, GaAs, III-V materials, II-VI materials, SiGe, and optical fiber. Whilst primarily waveguide-waveguide systems have been described it would be evident to one skilled in the art that embodiments of the invention may be employed in aligning intermediate coupling optics, e.g. ball lenses, spherical lenses, graded refractive index (GRIN) lenses, etc. for free-space coupling into and/or from a waveguide device.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
forming a pool comprising a bottom and a plurality of sidewalls;
disposing one or more liquids within the pool; and
selectively curing or solidifying a portion of the one or more liquids to form an optical waveguide which couples at a first end of the optical waveguide to a predetermined location upon a first optical component disposed towards a first end of the pool and at a second distal end of the optical waveguide to a predetermined location upon a second optical component disposed towards a second distal end of the pool.

2. The method according to claim 1, wherein selectively curing or solidifying the portion of the one or more liquids comprises illuminating a plurality of regions of the one or more liquids retained within the pool with optical radiation within a predetermined wavelength range; and
at least one of:
a cross-sectional geometry of the optical waveguide varies in a predetermined manner from the first end to the second distal end; and
the optical waveguide traverses a path from the first end to the second distal end comprising a horizontal component defined by a first predetermined function and a vertical component defined by a second predetermined function.

3. The method according to claim 1, wherein
selectively curing or solidifying the portion of the one or more liquids comprises irradiating a plurality of regions of the one or more liquids retained within the pool with radiation of a predetermined type and predetermined characteristics; and
at least one of:
a cross-sectional geometry of the optical waveguide varies in a predetermined manner from the first end to the second distal end; and
the optical waveguide traverses a path from the first end to the second distal end comprising a horizontal component defined by a first predetermined function and a vertical component defined by a second predetermined function.

4. The method according to claim 1, wherein
at least one of the first optical component and another substrate upon which the first optical component is either integrated within or mounted upon form a first sidewall of the plurality of sidewalls;
at least one of the second optical component and a carrier upon which the second optical component is either integrated within or mounted upon form a second sidewall of the plurality of sidewalls;
a third sidewall of the plurality of sidewalls is formed within the substrate; and
a fourth sidewall of the plurality of sidewalls is formed within the substrate.

5. The method according to claim 1, wherein
the first optical component is an optical waveguide;
the substrate is one of silicon, a glass or a ceramic; and
the second optical component is an optical fiber.

6. The method according to claim 1, wherein the third sidewall of the plurality of sidewalls is a first side of a groove within the substrate;
the fourth sidewall of the plurality of sidewalls is a second side of the groove opposite the first side; and
a portion of the first sidewall of the plurality of sidewalls is an end of the groove disposed between the first sidewall of the plurality of sidewalls and the second sidewall of the plurality of sidewalls where the end of the groove limits motion of an optical fiber within the groove.

7. The method according to claim 1, wherein
the third sidewall of the plurality of sidewalls is a first side of a groove within the substrate;
the fourth sidewall of the plurality of sidewalls is a second side of the groove opposite the first side;
a portion of the first sidewall of the plurality of sidewalls is an end of the groove disposed between the first sidewall of the plurality of sidewalls and the second sidewall of the plurality of sidewalls where the end of the groove limits motion of an optical fiber within the groove;
the end of the groove has a first predetermined geometry axial to the groove and a second predetermined geometry perpendicular to the groove in the plane of the substrate; and
the first predetermined geometry and second predetermined geometry provide for a region where the optical fiber abuts that fills with another liquid disposed between the optical fiber and the groove to provide repeatable and reproducible positioning of an end of the optical fiber against the end of the groove.

8. The method according to claim 1, wherein
the third sidewall of the plurality of sidewalls is a first side of a groove within the substrate;
the fourth sidewall of the plurality of sidewalls is a second side of the groove opposite the first side;
a portion of the first sidewall of the plurality of sidewalls adjacent the first sidewall is a first end of the groove disposed between the first sidewall of the plurality of sidewalls and the second sidewall of the plurality of sidewalls where the first end of the groove limits motion of an optical fiber within the groove; and
another portion of the first sidewall of the plurality of sidewalls adjacent the second sidewall is a second end of the groove disposed between the first sidewall of the plurality of sidewalls and the second sidewall of the plurality of sidewalls where the second end of the groove limits motion of an optical fiber within the groove.

9. The method according to claim 1, wherein
the third sidewall of the plurality of sidewalls is a first side of a groove within the substrate;
the fourth sidewall of the plurality of sidewalls is a second side of the groove opposite the first side;
a portion of the first sidewall of the plurality of sidewalls adjacent the first sidewall is a first end of the groove disposed between the first sidewall of the plurality of sidewalls and the second sidewall of the plurality of sidewalls where the first end of the groove limits motion of an optical fiber within the groove; and
another portion of the first sidewall of the plurality of sidewalls adjacent the second sidewall is a second end of the groove disposed between the first sidewall of the plurality of sidewalls and the second sidewall of the plurality of sidewalls where the second end of the groove limits motion of an optical fiber within the groove;
the first end of the groove has a first predetermined geometry axial to the groove and a second predetermined geometry perpendicular to the groove in the plane of the substrate;
the second end of the groove has a third predetermined geometry axial to the groove and a fourth predetermined geometry perpendicular to the groove in the plane of the substrate;
the first predetermined geometry and fourth predetermined geometry provide for a first region where the optical fiber abuts that fills with another liquid disposed between the optical fiber and the groove to provide repeatable and reproducible positioning of the end of the optical fiber against the end of the groove; and
the third predetermined geometry and the fourth predetermined geometry provide for a first region where the optical fiber abuts that fills with another liquid disposed between the optical fiber and the groove to provide repeatable and reproducible positioning of the end of the optical fiber against the end of the groove.

10. The method according to claim 1, wherein
the first optical component is an optical waveguide integrated within an optical circuit mounted to a carrier;
a first sidewall of the plurality of sidewalls is formed by the carrier and the optical circuit;
a second sidewall of the plurality of sidewalls is formed within a substrate; wherein in a first configuration:
a third sidewall of the plurality of sidewalls is formed within the substrate;
a fourth sidewall of the plurality of sidewalls is formed within the substrate;
the second optical component is an optical fiber mounted within a groove formed within the substrate; and
in a second configuration:
the second optical component is an optical fiber mounted within a groove formed within the substrate comprising at least a third sidewall of the plurality of sidewalls and a fourth sidewall of the plurality of sidewalls; and
the substrate and the carrier abut each other such that a facet of the first optical component and a facet of the optical fiber face one another.

11. The method according to claim 1, wherein
the first optical component is an optical waveguide integrated within an optical circuit mounted to a carrier;
a first sidewall of the plurality of sidewalls is formed by the carrier and the optical circuit;
the second optical component is an optical fiber mounted within a groove formed within the substrate;
the substrate and the carrier abut each other such that a facet of the first optical component and a facet of the optical fiber face one another;
a facet of the optical fiber forms a second sidewall of the plurality of sidewalls;
a first portion of the pool comprises the second sidewall of the plurality of sidewalls and a pair of third sidewalls of the plurality of sidewalls which form part of the groove within which the optical fiber is disposed extending beyond the facet of the optical fiber towards the first optical component;
a second portion of the pool comprises a pair of fourth sidewalls disposed opposite one another wherein the second portion of the pool is fluidically connected to the first portion of the pool and the third portion of the pool;
a third portion of the pool comprises a pair of fifth sidewalls disposed opposite one another extending from a first end of the third portion of the pool adjacent to the second portion of the pool to the end of the third portion of pool and a pair of sixth sidewalls each extending laterally adjacent to the second portion of the pool from a fourth sidewall of the pair of fourth sidewalls to a predetermined fifth sidewall of the pair of fifth sidewalls; and
the optical waveguide extends through the first portion of the pool, the second portion of the pool and the third portion of the pool.

12. The method according to claim 1, wherein a first portion of the pool is formed within a first substrate associated with the first optical component;
a second portion of the pool is formed within a second substate associated with the second optical component which is an optical fiber;
the second substrate comprises:
the second portion of the pool;
a first groove extending away from the second portion of the pool within which the optical fiber is positioned where the first groove is dimensioned in dependence upon a cladding of the optical fiber;
another pool disposed between an end of the first groove distal to the pool and a first end of a second groove; and
the second groove extending away from the another pool within which the optical fiber is positioned where the first groove is dimensioned in dependence upon a removable coating of the optical fiber; and
the another pool is filled with another liquid which is cured to attach the optical fiber to the second substrate where the attached optical fiber is stripped to its removable cladding within the first groove and a portion of the another pool and coating with its removable cladding a remaining portion of the another pool and the second groove.

13. The method according to claim 1, wherein
the pool is recess formed within a substrate;
the first optical component is an optical waveguide integrated within the substrate;
a first sidewall of the plurality of sidewalls is a facet within the substrate proximate an end of the optical waveguide integrated within the substrate;
the second optical component is an optical fiber;
a second sidewall of the plurality of sidewalls is a facet of the optical fiber;
a third sidewall of the plurality of sidewalls is a wall of the recess extending away from the first sidewall of the plurality of sidewalls;
a fourth sidewall of the plurality of sidewalls is another wall of the recess extending away from the first sidewall of the plurality of sidewalls;
the optical fiber has been inserted into a ratchet structure which comprises:
a first portion of the ratchet structure selectively released from the substrate within which the optical fiber is inserted which can move relative to a second portion of the ratchet structure under action of the optical fiber towards the facet within the substrate; and
a second portion of the ratchet structure extending along either side of the first portion attached to the substrate via a hinge disposed on one side of the first portion connected to the third sidewall of the plurality of sidewalls and another hinge disposed on another side of the first portion connected to the fourth sidewall of the plurality of sidewalls;
the second portion of the ratchet structure prevents movement of the first portion of the ratchet structure away from the facet within the substrate; and
the optical waveguide allows for variations in the position of the facet of the optical fiber relative to the end of the optical waveguide to be accommodated.

14. The method according to claim 13, further comprising
another pool disposed within the substate such that the another pool is disposed further away from the facet within the substate than the pool; and
the another pool is filled with another liquid which is cured to attach the optical fiber to the substrate once the optical fiber has been inserted into the ratchet structure.

15. A method comprising:
providing a micromachined silicon block (MSB) comprising:
a recess disposed at a facet of the MSB forming a first portion of a pool;
a first groove extending away from the recess within which an optical fiber is to be placed where the first groove is dimensioned in dependence upon a cladding of the optical fiber;
another pool disposed between at an end of the first groove distal to the recess and a first end of a second groove; and
the second groove which extends away from the another pool to a facet of the MSB distal to the recess within which the optical fiber is to be placed where the second groove is dimensioned in dependence upon a removable coating of the optical fiber;
placing the optical fiber onto the MSB such that a portion of the optical fiber stripped down to the cladding is disposed within the first groove and another portion of the optical fiber with the removable cladding still disposed around the cladding is disposed within the second groove; and
filling the another pool with a liquid which when cured attaches the optical fiber to the MSB.

16. The method according to claim 15, further comprising
providing the second portion of the pool where the second portion of the pool is formed within an edge of a substrate associated with an optical component attached to a carrier;
positioning the MLB with the optical fiber assembled upon it upon the carrier such that the facet of the MLB comprising the recess as the first portion of the pool abuts the second portion of the pool formed within the edge of the substrate;
attaching the MLB onto the carrier;
disposing one or more other liquids within the pool; and
selectively curing or solidifying a portion of the one or more other liquids to form an optical waveguide which couples at a first end of the optical waveguide to a predetermined location with respect to an end of the optical component disposed towards the second portion of the pool and at a second distal end of the optical waveguide at another predetermined location with respect to an end of the optical fiber disposed towards the first portion of the pool.

17. The method according to claim 16, wherein
the optical component is one of a laser diode, a light emitting diode, a semiconductor optical amplifier and a photodetector.

18. The method according to claim 16, wherein
the optical component is an optical waveguide integrated within the substrate.

19. The method according to claim 16, further comprising
positioning an other MLB with another optical fiber assembled upon it upon the carrier such that the facet of the other MLB comprising the recess is the first portion of an other pool which abuts another second portion of the other pool formed within another edge of the substrate;
attaching the other MLB onto the carrier;
disposing one or more other liquids within the other pool; and
selectively curing or solidifying a portion of the one or more other liquids to form an other optical waveguide which couples at a first end of the optical waveguide to a predetermined location with respect to an other end of the optical component disposed towards the second portion of the other pool and at a second distal end of the optical waveguide at another predetermined location with respect to an end of the other optical fiber attached to the other MLB disposed towards the first portion of the other pool.
